(19) United States
(12) Patent Application Publication
(10) Pub. No.: US 2005/0271459 A1
(43) Pub. Date: Dec. 8, 2005

(54) Interlocking ring tip formations for paired ring members of a ring binder mechanism

(75) Inventors: Chun Y. To, Hong Kong (CN); Hung Y. Cheng, Hong Kong (CN); Ho P. Cheng, Hong Kong (CN)

Correspondence Address: SENNIGER POWERS LEAVITT AND ROEDEL, ONE METROPOLITAN SQUARE, 16TH FLOOR, ST LOUIS, MO, 63102, US

(73) Assignee: World Wide Stationery Mfg. Co., Ltd., Hong Kong (CN)

(21) Appl. No.: 10/967,882

(22) Filed: Oct. 18, 2004

(30) Foreign Application Priority Data
Jun. 3, 2004 (CN) 200430060502.0
Jun. 3, 2004 (CN) 200430060503.5
Jun. 29, 2004 (CN) 200410061917.9
Jun. 3, 2004 (CN) 200430060501.6
Jun. 3, 2004 (CN) 200430060504.X

(51) Int. Cl. B42F 3/04

(52) U.S. Cl. 402/31

(57) ABSTRACT

A ring binder mechanism for retaining loose-leaf pages comprises a housing supporting two hinge plates for pivoting motion to open and close ring members. Paired ring members of the mechanism attach to the hinge plates and move therewith between the open and closed positions. Free ends of the paired ring members each have a interlocking formation that is capable of securely joining together when the ring members are in the closed position. The interlocking formations hold the ring members against misalignment in all directions transverse to longitudinal centerlines of the ring members when the ring members are in the closed position. Some formations are additionally capable of positively engaging each other as the ring members come together to actively bias the ring members into accurate alignment.

### BACKGROUND OF THE INVENTION

This invention relates to a ring binder mechanism for retaining loose-leaf pages, and in particular to an improved mechanism having paired ring members with free end tip formations that prevent misalignment between closed ring members.

As is known in the art, a typical ring binder mechanism retains loose-leaf pages, such as hole-punched papers, in a file or notebook. It generally features multiple rings, each including two half ring members that mount on two adjacent hinge plates. The hinge plates join together about a pivot axis and pivot within an elongated housing, allowing the ring members mounted thereon to move between an open position where pages may be added or removed, and a closed position where pages are retained and can move along the rings. An operator may typically open or close the ring members by manually pulling the ring members apart or pushing them together. In addition, in some mechanisms the operator can move a lever located at one or both ends of the mechanism to open or close the ring members.

The paired ring members of these known mechanisms often have free ends with tip formations that do not always exactly align when the ring members are closed, and misalignment of the ring members in directions transverse to longitudinal centerlines of the ring members is common. Moreover, even if alignment is initially perfect upon closure, the free ends may still be able to move relative to each other. The engagement of the ring member free ends may be capable of resisting displacement in one direction, but most commonly there is no resistance to displacement in a second, perpendicular direction. For example, the ring member free ends are often shaped to resist relative displacement toward and away from the longitudinal axis of the ring binder mechanism, but provide no resistance to relative movement in directions along the length of the ring binder mechanism. Accordingly, pages bound by these known mechanisms may not smoothly move from one ring member to the other and may be torn.

It is known to provide paired ring members having free ends with tip formations consisting of a bowl-shaped cavity in the free end of one ring member and a correspondingly shaped projection in the other ring member. An example is shown in co-assigned U.S. patent application Publ. No. 2004/0013463 (To). When mechanisms with these ring members are closed, the cavity of one ring member receives projection of the other ring member and the mating free ends generally accurately align and resist misalignment in all directions. But these ring members still have disadvantages. For example, the projections are often relatively slender and therefore may be difficult to manufacture. They may also be weak or fragile and prone to damage during the manufacturing process or during operation. In addition, the concave portions may be difficult to manufacture because they generally require boring holes into the free end of the respective ring member. Tools used to form these holes are necessarily small and may be easily damaged during the manufacturing process. Moreover, each of these disadvantages can be significantly amplified when the ring members are made of relatively small gauge metal and have significantly smaller free ends because the cavity and projection must be smaller. Accordingly, manufacturing these known ring members may be inefficient and expensive. Since the ring binder industry is generally based on mass production, inefficiencies and added expenses can be considerable.

It is also known to provide paired ring members having free end tip formations that are substantially similar, with one formation being rotated relative to the mating formation. An example is shown in U.S. Pat. No. 2,119,639 (Lotter). When mechanisms with these ring members are closed, the mating free ends generally accurately align. But these formations have similar disadvantages to the convex and concave formations. They may be complexly shaped and relatively difficult to produce, and manufacturing may again be inefficient and production costs may again be high. In addition, some formations may comprise relatively sharp or pointed features that can injure an operator if a finger is inadvertently caught between closing ring members or that can damage pages when they are added or removed from the rings.

Accordingly, there is a need for a ring binder mechanism having paired ring members with free end formations that are efficient to fabricate and that effectively prevent misalignment of closed ring members in all directions transverse to longitudinal centerlines of the ring members.

### SUMMARY OF THE INVENTION

The present invention provides an improved ring binder mechanism having paired ring members with free end tip formations that prevent misalignment between closed ring members. In one aspect, a ring binder mechanism of the invention retains loose-leaf pages and generally comprises a housing which supports rings for holding the pages. Each ring includes a first ring member and a second ring member that each have a longitudinal centerline. The first ring member is moveable relative to the second ring member so that in a closed position a free end of the first ring member joins with a free end of the second ring member, and so that in an open position the free end of the first ring member separates from the free end of the second ring member. The free ends of both ring members have an interlocking formation with substantially the same shape, and the interlocking formation of the second ring member is rotated about the longitudinal centerline of the second ring member relative to the interlocking formation of the first ring member an angle that is greater than 0° but less than 90°.

In another aspect of the invention, the first and second ring members each have an interlocking formation at their free end that is interengagable with the interlocking formation of the other ring member when in the closed position to resist misalignment of the closed ring members both in a direction that is parallel to a longitudinal axis of the ring binder mechanism and in a direction that is perpendicular to the longitudinal axis of the ring binder mechanism. The interlocking formation of the first ring member comprises at least three substantially identical and spaced apart fingers that extend longitudinally outward from the free end of the first ring member.

In a further aspect of the invention, the first and second ring members each have an interlocking formation at their free ends that is interengagable with the interlocking formation of the other ring member when the ring members are in the closed position to resist misalignment of the ring members. The interlocking formations of the first and second ring members each have at least two recesses. The recesses of the interlocking formation of the first ring member extend along a surface of the free end the full dimension of the ring member transverse to the longitudinal centerline of the ring member. The recesses intersect about where the longitudinal centerline of the first ring member extends through the surface of the free end.

In still another aspect of the invention, the free end of the first ring member has a tongue that extends along a surface of the free end transversely to the longitudinal centerline of the first ring member. The free end of the second ring member has a recess that extends uniformly along a surface of the free end transversely to the longitudinal centerline of the second ring member the full width of the second ring member. The recess of the second ring member is adapted to receive the tongue of the first ring member, and the two are arranged relative to each other such that when the free ends of the two ring members join in the closed position, the recess and tongue interact to resist misalignment of the closed ring members both in a direction that is parallel to a longitudinal axis of the ring binder mechanism and in a direction that is perpendicular to the longitudinal axis of the ring binder mechanism.

In yet a further aspect of the invention, the free end of the first and second ring member each have an interlocking formation with substantially the same shape. The interlocking formations of both ring members generally comprise a tongue that extends longitudinally outward from a surface of the respective free end and that also extends along a surface transversely to the longitudinal centerline of the respective ring member. The tongues of both ring members have two spaced apart fingers that extend longitudinally outward from the tongue and terminate in blunt ends for preventing the fingers from inadvertently tearing the pages retained by the mechanism. The interlocking formation of the second ring member is rotated about the longitudinal centerline of the second ring member relative to the interlocking formation of the first ring member an angle that is about 90°.

Other objects and features of the invention will be in part apparent and in part pointed out hereinafter.

### BRIEF DESCRIPTION OF THE DRAWINGS

FIG. 1 is a perspective of a ring binder mechanism having three rings each with first and second ring members incorporating interlocking formations of this invention and at a closed position;

FIG. 2 is an exploded perspective of the mechanism;

FIG. 3A is an enlarged perspective of a free end of the first ring member of a ring of the mechanism of FIG. 1 with the free end incorporating a first interlocking formation according to a first version of a first embodiment of the invention;

FIG. 3B is an enlarged perspective of a free end of the second ring member of the ring with the free end incorporating a second, mating interlocking formation according to the first version for joining with the first interlocking formation of the ring member of FIG. 3A;

FIG. 4A is an enlarged front elevation of the first interlocking formation of the first ring member of FIG. 3A;

FIG. 4B is an enlarged left side elevation thereof;

FIG. 5 is an enlarged front elevation of the second interlocking formation of the second ring member of FIG. 3B;

FIG. 6A is a schematic showing the pair of interlocking formations of the first and second ring members of FIGS. 3A and 3B joining together;

FIG. 6B is the schematic of FIG. 6A with the ring members in the closed position and the interlocking formations joined together;

FIG. 7A is an enlarged perspective of a free end of the first ring member of a ring of the mechanism of FIG. 1 with the free end incorporating a first interlocking formation according to a second version of the first embodiment;

FIG. 7B is an enlarged perspective of a free end of the second ring member of the ring with the free end incorporating a second, mating interlocking formation according to the second version for joining with the first interlocking formation of the ring member of FIG. 7A;

FIG. 8A is an enlarged front elevation of the first interlocking formation of the first ring member of FIG. 7A;

FIG. 8B is an enlarged left side elevation thereof;

FIG. 9 is an enlarged front elevation of the second interlocking formation of the second ring member of FIG. 7B;

FIG. 10A is an enlarged perspective of a free end of the first ring member of a ring of the mechanism of FIG. 1 with the free end incorporating a first interlocking formation according to a third version of the first embodiment;

FIG. 10B is an enlarged perspective of a free end of the second ring member of the ring with the free end incorporating a second, mating interlocking formation according to the third version for joining with the first interlocking formation of the ring member of FIG. 10A;

FIG. 11A is an enlarged front elevation of the first interlocking formation of the first ring member FIG. 10A;

FIG. 11B is an enlarged left side elevation thereof;

FIG. 12 is an enlarged front elevation of the second interlocking formation of the second ring member FIG. 10B;

FIG. 13A is an enlarged perspective of a free end of the first ring member of a ring of the mechanism of FIG. 1 with the free end incorporating a first interlocking formation according to a second embodiment of the invention;

FIG. 13B is an enlarged perspective of a free end of the second ring member of the ring with the free end incorporating a second, mating interlocking formation according to the second embodiment for joining with the first interlocking formation of the ring member of FIG. 13A;

FIG. 14A is an enlarged front elevation of the first interlocking formation of the first ring member of FIG. 13A;

FIG. 14B is a section taken on line 14B-14B of FIG. 14A;

FIG. 14C is an enlarged top plan of the first interlocking formation of FIG. 13A;

FIG. 15 is an enlarged front elevation of the second interlocking formation of the second ring member of FIG. 13B;

FIG. 16A is a schematic showing the pair of interlocking formations of the first and second ring members of FIGS. 13A and 13B joining together;

FIG. 16B is the schematic of FIG. 16A with the ring members in a closed position and the interlocking formations joined together;

FIG. 17A is an enlarged perspective of a free end of the first ring member of a ring of the mechanism of FIG. 1 with the free end incorporating a female interlocking formation according to a third embodiment of the invention;

FIG. 17B is an enlarged perspective of a free end of the second ring member of the ring with the free end incorporating a male interlocking formation according to the third embodiment for joining with the female interlocking formation of the ring member of FIG. 17A;

FIG. 18A is an enlarged front elevation of the male interlocking formation of the second ring member of FIG. 17B;

FIG. 18B is an enlarged left side elevation thereof;

FIG. 19A is a schematic showing the pair of interlocking formations of the first and second ring members of FIGS. 17A and 17B joining together; and

FIG. 19B is the schematic of FIG. 19A with the ring members in a closed position and the interlocking formations joined together.

Corresponding reference characters indicate corresponding parts throughout the several views of the drawings.

### DETAILED DESCRIPTION OF THE INVENTION

This application contains subject matter in common with co-assigned, co-pending design patent application Ser. No. ______ filed simultaneously herewith for a Complementary Ring Tip Pair for Joining Ring Members of a Ring Binder Mechanism, the entire disclosure of which is hereby incorporated by reference.

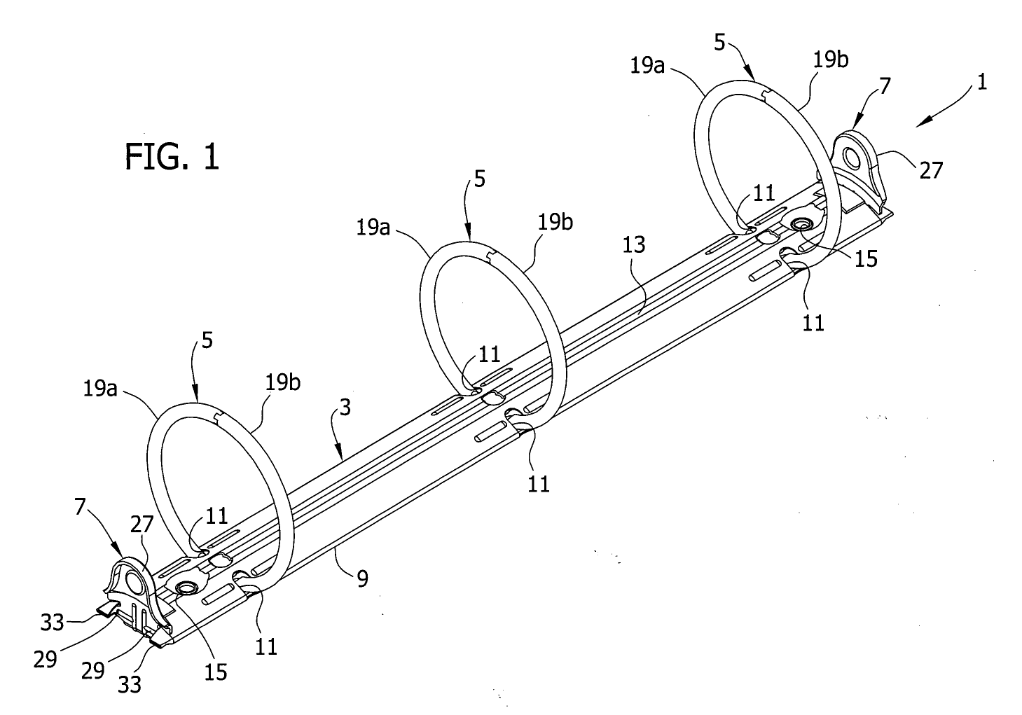

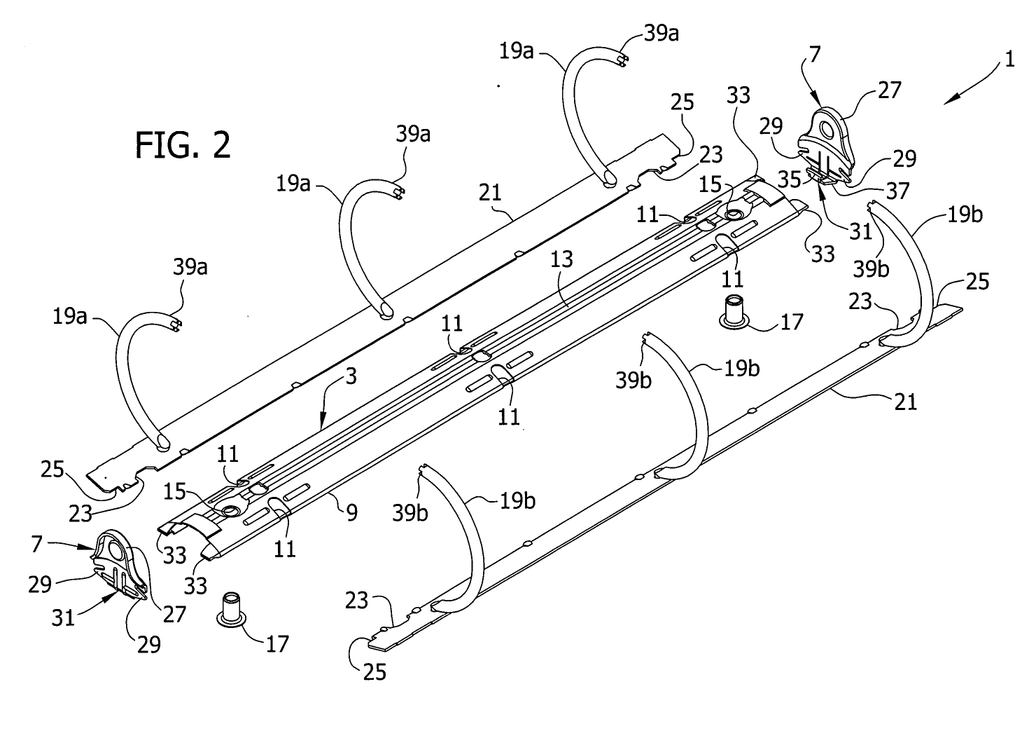

Referring now to the drawings of this invention, and particularly to FIGS. 1 and 2, a ring binder mechanism of the invention is shown designated generally by reference numeral 1. The illustrated mechanism 1 generally includes an elongate housing 3 for mounting on a cover (not shown) and three rings, each designated generally by reference numeral 5, supported by the housing 3 for retaining loose-leaf pages (not shown). A pair of substantially similar actuating levers, each generally designated by reference numeral 7, are provided adjacent longitudinal ends of the housing 3 to operate the mechanism 1 and either open the rings 5 for adding or removing pages or close them for retaining pages. It is to be understood that a mechanism mounted on surfaces other than a cover or a mechanism used to retain papers other than loose-leaf pages does not depart from the scope of this invention. It is to be further understood that a mechanism without levers or with levers differently positioned than illustrated herein does not depart from the scope of the invention.

The illustrated housing 3 is generally elongate with a symmetrical, roughly arch-shaped cross section. It has a longitudinal axis, two transversely opposite longitudinally extending edges, and the two longitudinal ends. A bent under rim 9 is formed along each longitudinal edge of the housing 3, and each bent under rim 9 has three slots 11 (only one rim 9 is visible in the drawings). The slots 11 are arranged in three transversely opposed pairs along the length of the housing 3 for receiving the rings 5 and allowing them to open and close. An upper surface 13 of the housing has two circular openings 15 adjacent the housing's longitudinal ends for receiving and attaching mounting posts 17 (FIG. 2) to the housing 3. The mounting posts 17 are capable of securing the mechanism 1 to a cover of files, ring binders and the like, or to structures not constituting a cover (not shown). It is envisioned that the housing is made of metal, but it is understood that it may be made of other suitable material that is sufficiently rigid to provide a stable mount for components of the mechanism. In addition, different shaped housings, including asymmetrical ones, and housings with different numbers of openings or slots therein do not depart from the scope of this invention.

As is generally known, the rings 5 supported by the housing 3 each include two joining ring members 19a and 19b. The ring members 19a, 19b each have a generally circular cross section and are formed of suitable material such as steel. When they are in a closed position (e.g., FIG. 1), the two ring members 19a, 19b of each ring form a substantially continuous, closed, ring or loop for retaining loose-leaf pages (not shown) and for allowing the pages to move along the rings 5 from one ring member 19a, 19b to the other. When they are in an open position (not shown), the ring members 19a, 19b form a discontinuous, open loop suitable for adding or removing pages. Although in the illustrated embodiment both ring members can move, a mechanism having one movable ring member and one fixed does not depart from the scope of this invention. Additionally, a mechanism with more or fewer than three rings or with rings that form other shapes, such as a “D” shape, when closed does not depart from the scope of this invention. Moreover, a mechanism with ring members having a different cross section shape, for example a generally oval cross section, does not depart from the scope of the invention.

As best shown in FIG. 2, the ring members 19a, 19b of each ring are mounted on one of a pair of adjacent hinge plates, each designated by reference numeral 21. Each hinge plate 21 is thin and elongate, and has an inner and outer longitudinal edge margin and two longitudinal ends. As is known in the art, the hinge plates 21 interconnect in parallel arrangement along their adjoining inner longitudinal edge margins to form a central hinge having a pivot axis, which allows the two plates 21 to pivot relative to each other and move the respective ring members 19a, 19b of each ring between the closed position and the open position. The connected plates 21 are generally received by the housing 3 such that each plates' outer longitudinal edge margin loosely fits above the housing's corresponding bent under rim 9. Accordingly, the hinge plates 21 are retained on the housing 3 but their outer edges are free to move within the rims 9, allowing the plates 21 to freely pivot about the pivot axis. The pivot axis moves up (i.e., toward the housing's upper surface 13) when the hinge plates 21 pivot to open the ring members 19a, 19b, and it moves down (i.e., away from the housing's upper surface 13) when the plates 21 pivot to close the ring members.

A pair of rounded cutouts 23 are positioned along the inner longitudinal edge margin of each hinge plate 21, while squared notches 25 are similarly positioned along the inner edge margins at the ends of each plate 21. When the hinge plates 21 interconnect, corresponding cutouts 23 in the adjacent plates 21 align and form two openings symmetrically positioned about the pivot axis of the plates. These openings receive the mounting posts 17 therethrough, and allow the hinge plates 21 to pivot relative to the posts 17 without engaging them. The notches 25 similarly align and form box-shaped recesses at the opposite ends of the plates 21. Each recess receives a portion of the respective actuating lever 7, as will be described in greater detail hereinafter, and allows the levers to interact with the hinge plates 21 to open and close the ring members 19a, 19b.

As shown in FIGS. 1 and 2, the two actuating levers 7 of the illustrated mechanism 1 are generally known and are substantially similar to actuating levers described and illustrated in co-owned U.S. application Ser. No. 10/886,069 (Ng) filed on Jul. 7, 2004 entitled Ring Binder Mechanism With Reinforced Hinge Plates, the entire disclosure of which is hereby incorporated by reference. Generally, each lever 7 includes a relatively flat head 27 that extends upward from the lever above the housing 3 for allowing an operator to grasp and pivot the lever 7. Each lever 7 additionally includes two lateral arms, each designated by reference numeral 29, and a cam, designated generally by reference numeral 31. The arms 29 extend laterally outward from opposite sides of each lever 7, generally below the flat head 27, and loosely fit within two pockets, each designated by reference numeral 33, located at the longitudinal ends of the housing 3 for pivoting within the pockets relative to the housing 3 about an axis transverse to the housing (FIG. 1). The cam 31 of each lever is integrally attached to the lever 7 below the lateral arms 29 and extends downward from the arms and curves outward from the flat head 27 to fit into one of the respective box-shaped recesses (formed by notches 25) of the hinge plates 21. An enlarged tab 35 of each cam (the tab of only one cam is shown in the drawings) generally fits loosely over the interconnected hinge plates 21 while a base 37 of each cam generally rests below the plates. Together, the tab 35 and base 37 releasably lock the hinge plates 21 therebetween for operable engagement to control the pivoting motion of the hinge plates 21 that close and open the ring members 19a, 19b. In operation (not shown), to close the ring members 19a, 19b, the levers 7 are pivoted upward and inward. The tabs 35 of each lever engage a top surface of the hinge plates 21 and pull the pivot axis of the plates 21 downward. To open the ring members 19a, 19b, the levers 7 are pivoted outward and downward. The bases 37 of each lever engage a bottom surface of the hinge plates 21 and push the pivot axis of the plates upward.

In this mechanism 1, it is to be understood that the housing 3 is slightly narrower than the joined hinge plates 21 when the hinge plates are in a coplanar position (i.e., an angle between exterior surfaces of the hinge plates 21 is 180°). So as the hinge plates 21 pivot through this position, they deform the resilient housing 3 and cause a spring force in the housing that urges the hinge plates 21 to pivot away from the coplanar position, either closing the ring members 19a, 19b (i.e., moving the pivot axis down and away from the housing's upper surface 13) or opening them (i.e., moving the pivot axis up and toward the housing's upper surface 13). Moreover, when the ring members 19a, 19b are closed, this spring force of the housing 3 resists hinge plate movement and clamps the ring members together. When the ring members 19a, 19b are open, the spring force holds them apart. It is to be understood that other mechanisms for obtaining relative movement of the ring members may be used without departing from the scope of the invention.

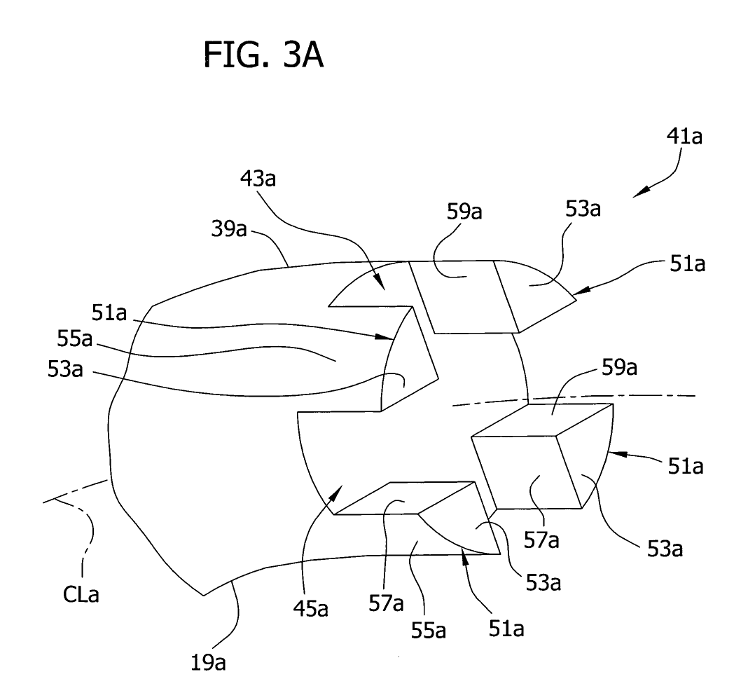

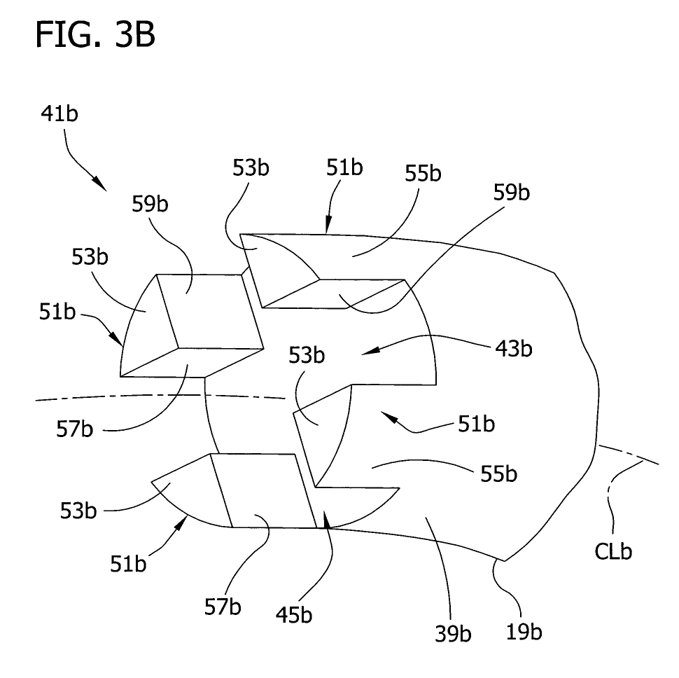

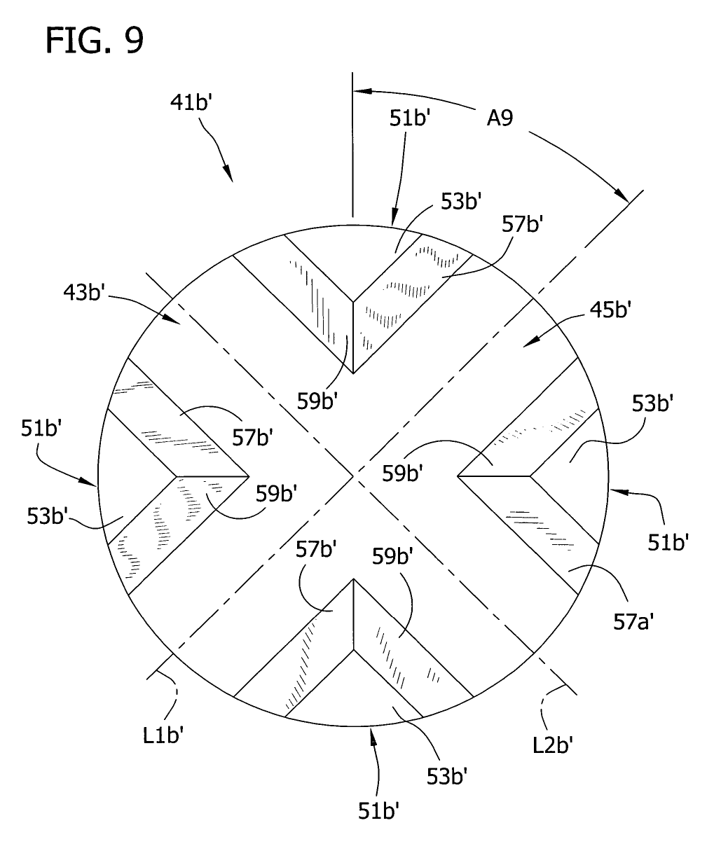

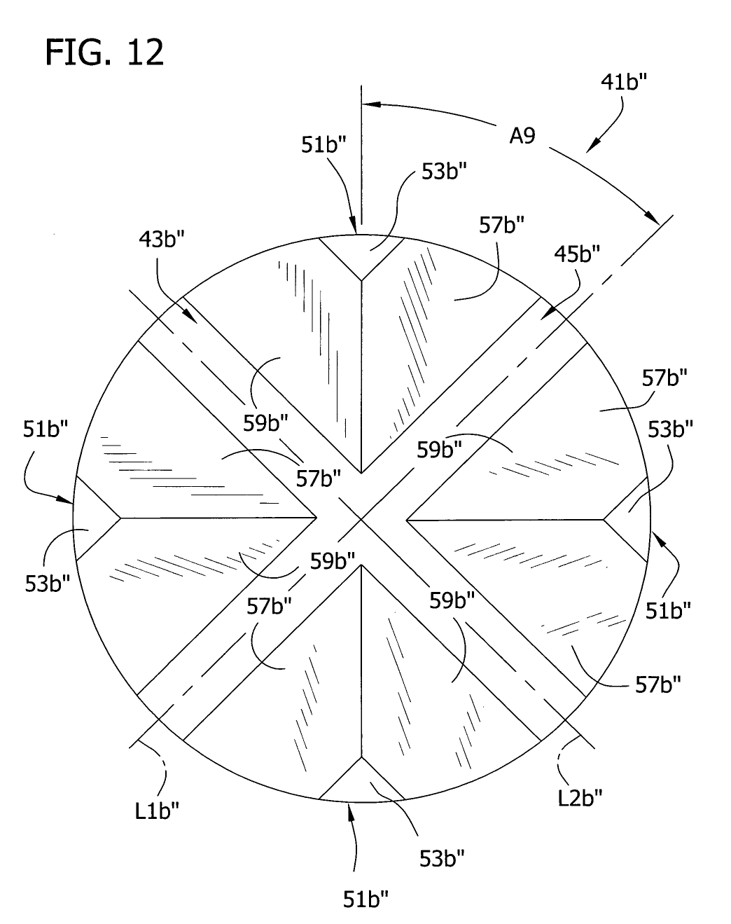

Referring particularly to FIG. 2, the pairs of joining ring members 19a, 19b of each ring each include a free end 39a, 39b that is longitudinally opposite the end mounted on the respective hinge plate 21. Each free end 39a, 39b generally includes a pair of interlocking formations that engage each other as the ring members 19a, 19b close and hold the closed ring members in accurate alignment (e.g., FIG. 1). A first version of a first embodiment of the pair of interlocking tip formations of this invention is shown in FIGS. 3A-12. As shown in FIGS. 3A and 3B, the pair of interlocking formations are each incorporated into one of the respective free ends 39a, 39b of the joining ring members and are each designated generally by reference numeral 41a and 41b, respectively. As can be seen by comparing FIGS. 3A and 3B, the two interlocking formations 41a, 41b have substantially the same shape. So for convenience, a first interlocking formation 41a of the pair will be described hereinafter with it to be understood that a description of a second, mating interlocking formation 41b would be substantially the same.

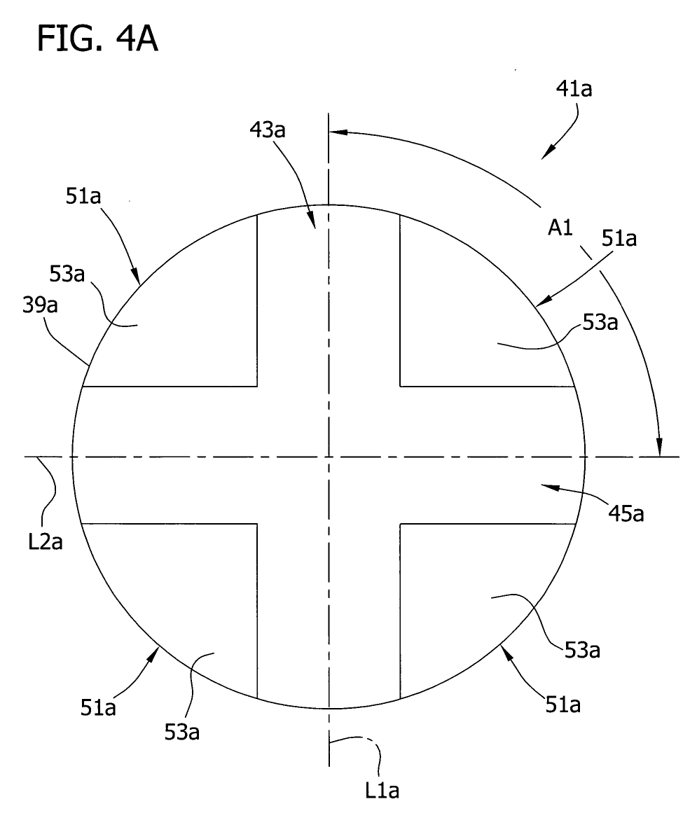

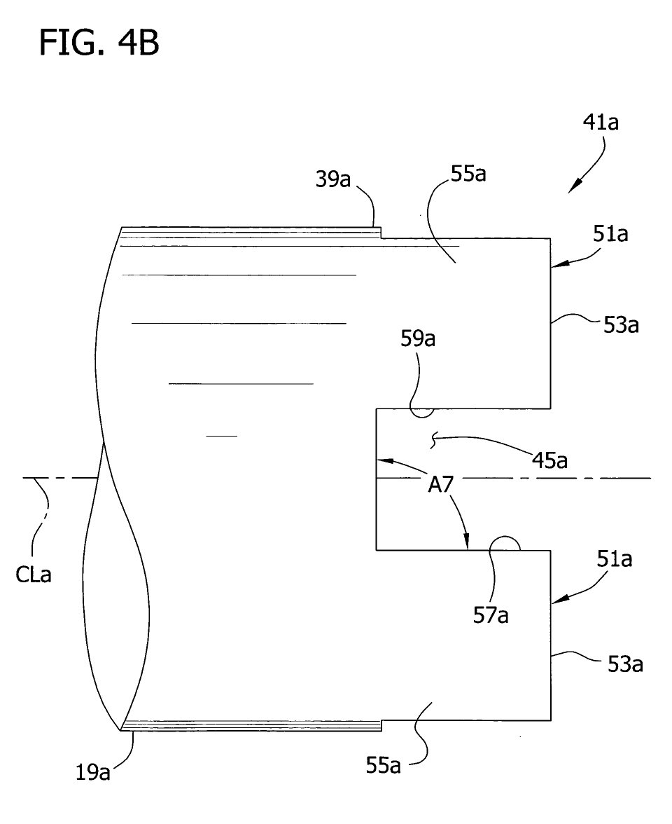

Referring now to FIGS. 3A and 4A-5, the first interlocking formation 41a includes first and second relatively linear, channel-shaped recesses designated generally by reference numerals 43a and 45a, respectively. The recesses 43a, 45a uniformly extend along diameters of the free end 39a, and floors of the recesses are generally flat and oriented relatively perpendicular to a longitudinal centerline CLa (FIGS. 3A and 4B) of the ring member 19a. A width of each recess 43a, 45a is less than the diameter of the free end 39a of the ring member. As best shown in FIG. 4A, the two illustrated recesses 43a, 45a extend along respective longitudinal axes L1a and L2a and define an angle A1 relative to each other of about 90°. In this arrangement, the two recesses 43a, 45a intersect one another near a center of the free end 39a. It is to be understood that a mechanism with ring members having recesses oriented differently does not depart from the scope of the invention. It is additionally understood that a mechanism with joining ring members having a cross section that does not necessarily have a diameter, for example an oval cross section, does not depart from the scope of this invention.

The intersecting recesses 43a, 45a divide the free end 39a of the ring member into four substantially similar, spaced apart fingers that are each designated generally by reference numeral 51a. The fingers 51a are uniformly spaced around a perimeter of the free end 39a and, as shown in FIGS. 3A and 4B, are each about the same length. It is envisioned that each finger is formed as one piece with the ring member, however a mechanism in which fingers are formed separately from ring members does not depart from the scope of the invention. In addition, it is understood that a mechanism with ring members having interlocking formations that include greater or fewer than four fingers does not depart from the scope of the invention.

The illustrated fingers 5la each generally include a relatively flat triangular top 53a and three substantially vertical side walls 55a, 57a, 59a. A surface of each top 53a is relatively parallel to surfaces of the other tops and to surfaces of the floors of the recesses 73a, 45a. Referring to FIGS. 3A and 4A, each top 53a generally includes a relatively arcuate outer edge that aligns with the perimeter of the free end 39a, and two substantially linear inner edges that extend away from the arcuate outer edge and meet at an inner vertex. One side wall 55a of the finger is generally arcuate and is a continuous extension of an outer surface of the ring member 19a, extending perpendicularly away from the arcuate edge of the top 53a. The other two side walls 57a, 59a are each relatively flat and extend perpendicularly away from the linear edges of the top 53a and intersect the respective recess floors at an angle A7 (in the drawings, this angle A7 is only illustrated with respect to the floor of the second recess 45a). In the illustrated embodiment, this angle A7 is about 90°, but as will become apparent hereinafter, it can be other than about 90° without departing from the scope of the invention. Additionally in the illustrated embodiment, the edges of each finger 51a as well as the edges between the flat sides 57a, 59a and the floors of the recesses 43a, 45a are shown to be relatively sharp, but a mechanism in which these edges are chamfered does not depart from the scope of the invention.

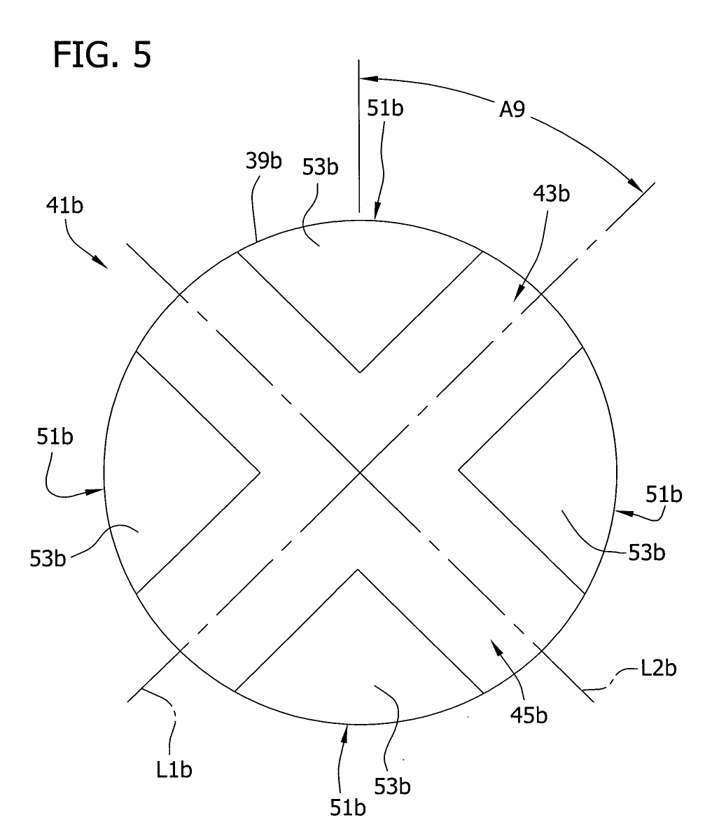

The second, mating interlocking formation 41b of the pair of interlocking formations is shown in FIGS. 3B and 5. As was previously described, the shape of this formation 41b is substantially the same as the shape of the first formation 41a. But as seen by comparing FIG. 5 to FIG. 4A, the second interlocking formation 41b (FIG. 5) is rotated an angle A9 about a longitudinal centerline CLb (FIG. 3B) of the second ring member 19b relative to the first interlocking formation 41a (FIG. 4A). In the illustrated embodiment the relative angle A9 of rotation is about 45°, but it is understood that a mechanism having ring members with corresponding interlocking formations oriented differently (e.g., a first interlocking formation rotated an angle different from 45° about a longitudinal centerline of its ring member relative to a second interlocking formation) does not depart from the scope of the invention. More generally, the angle of relative rotation is equal to 180° divided by the number of fingers of the interlocking formation, where the number of fingers is at least three.

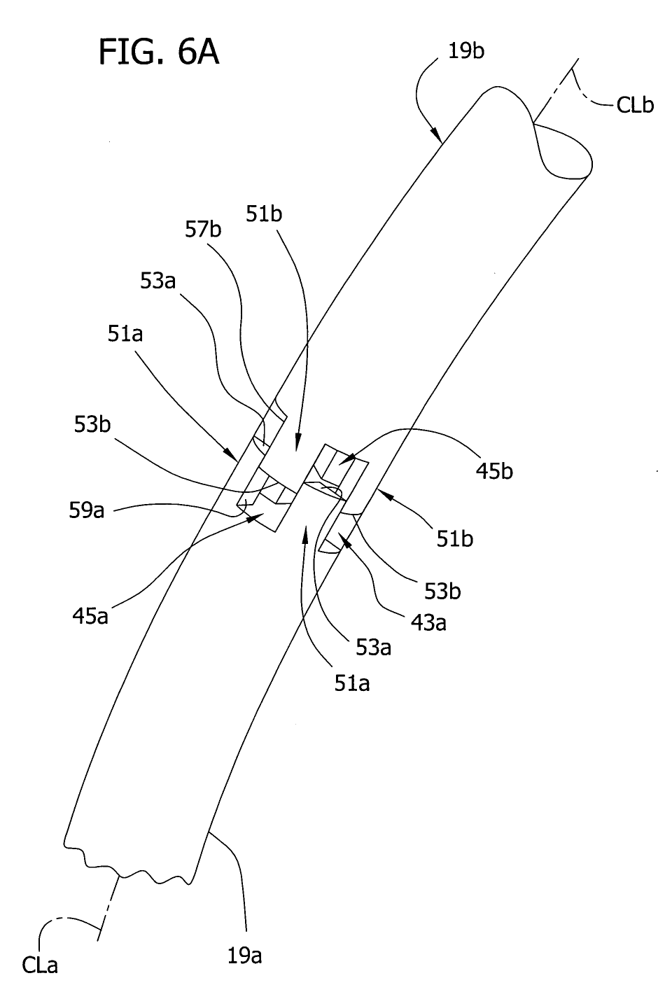

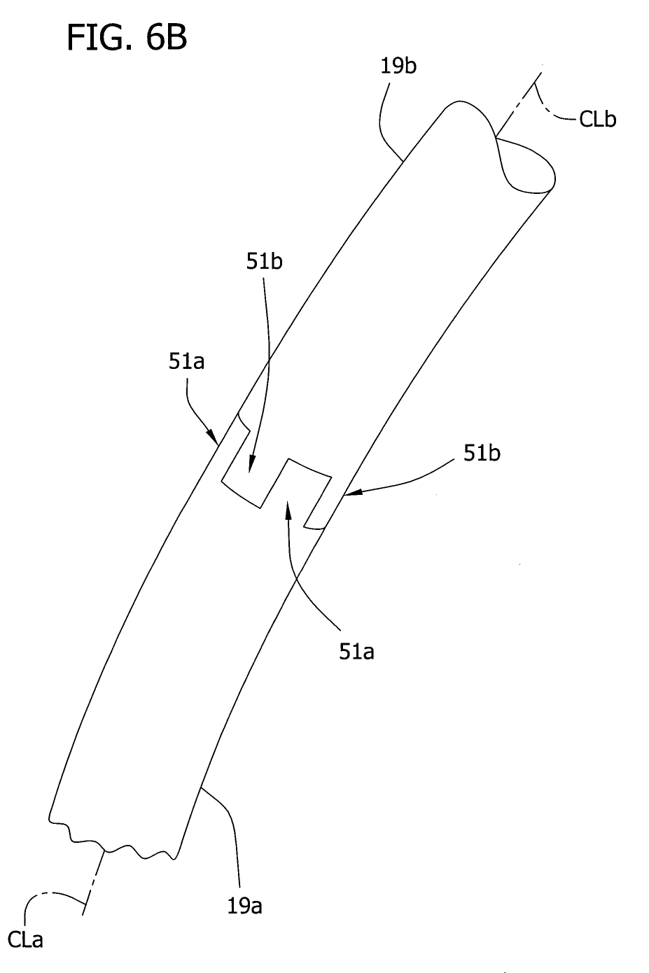

As shown in FIGS. 6A and 6B, the complementary relationship between the pair of interlocking formations 41a, 41b of the invention allows the fingers 51a, 51b of one ring member to accurately fit within the respective recesses 43a, 45a, 43b, 45b of the other ring member so that when the two paired ring members 19a, 19b are moved to the closed position they completely align. The tops 53a, 53b of the fingers of one ring member engage the floors of the respective recesses 43a, 45a, 43b, 45b of the other ring member and corresponding flat side walls 57a, 59a, 57b, 59b of corresponding fingers abut, thus ensuring generally complete alignment of the ring members 19a, 19b in all directions transverse to the longitudinal centerlines CLa and CLb of the ring members.

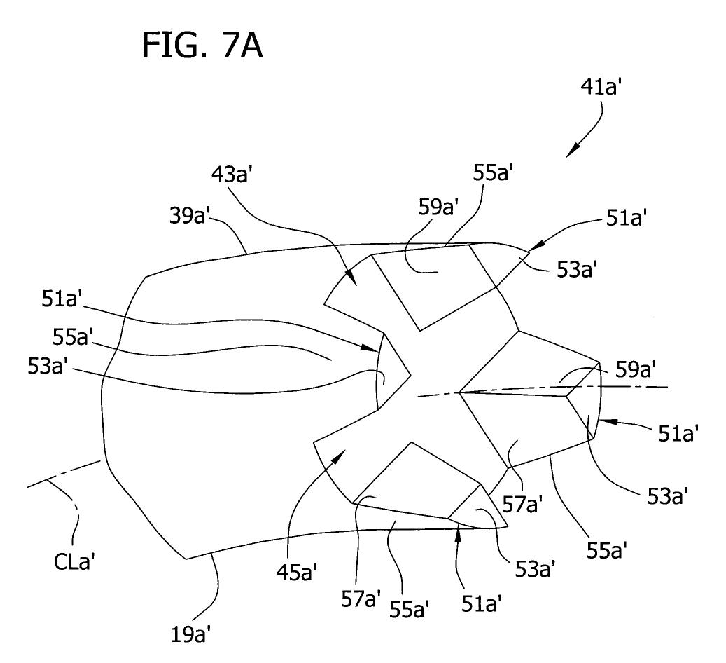

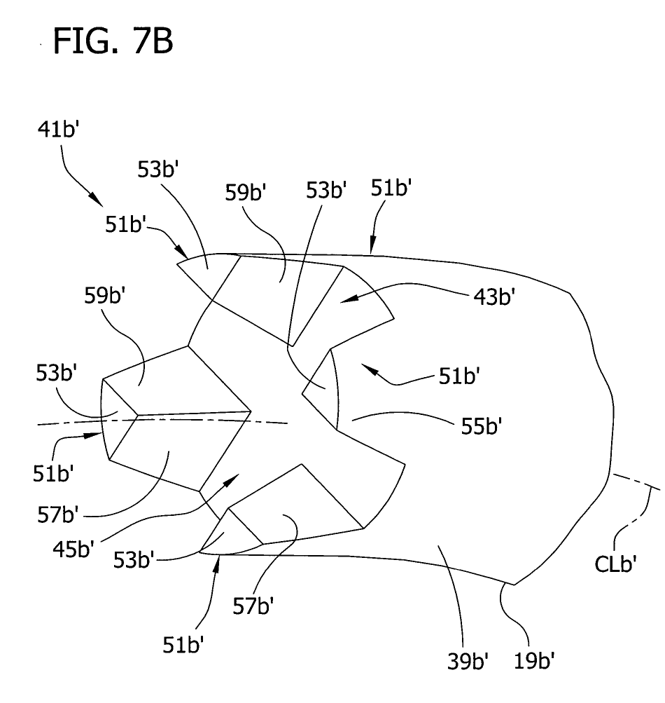

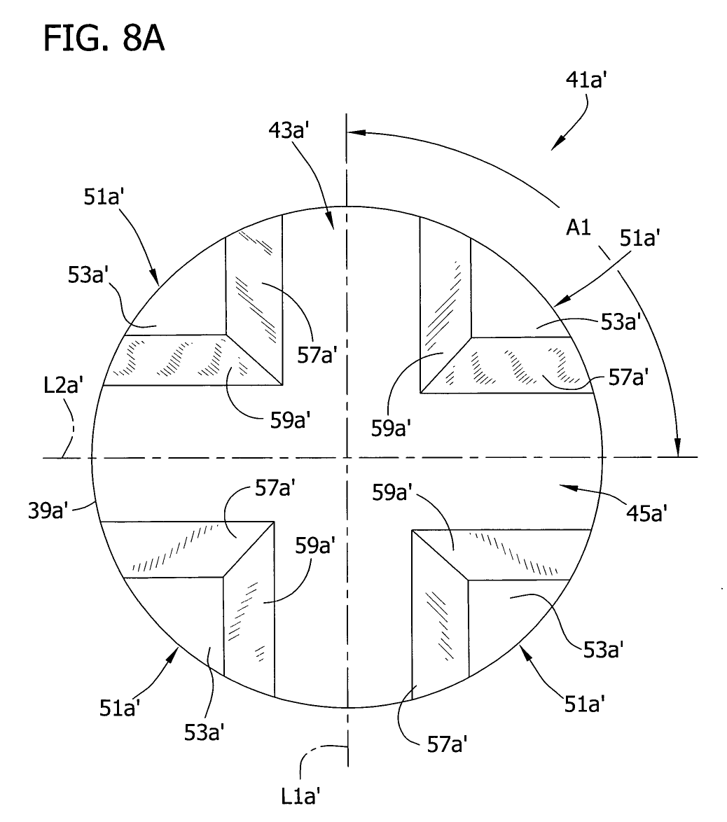

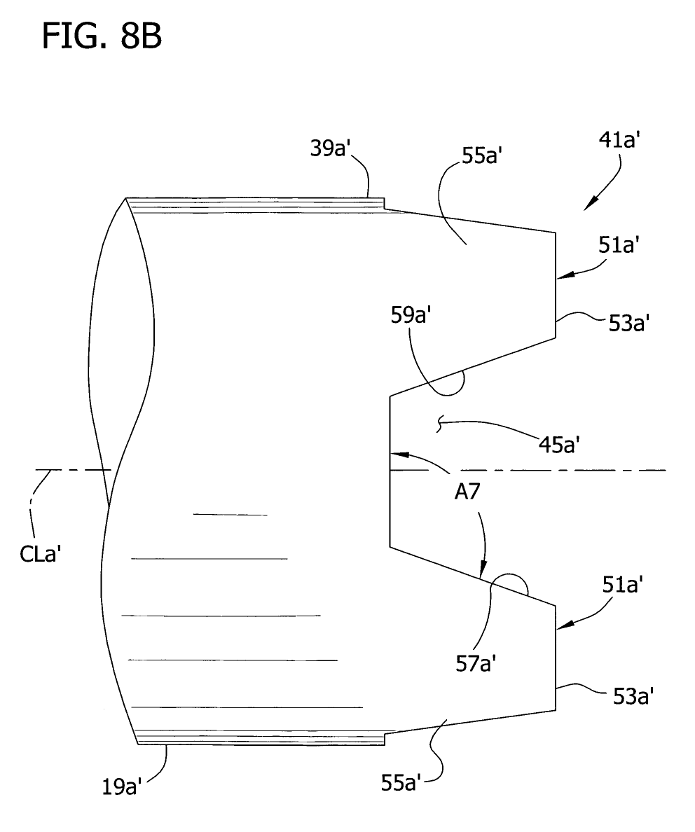

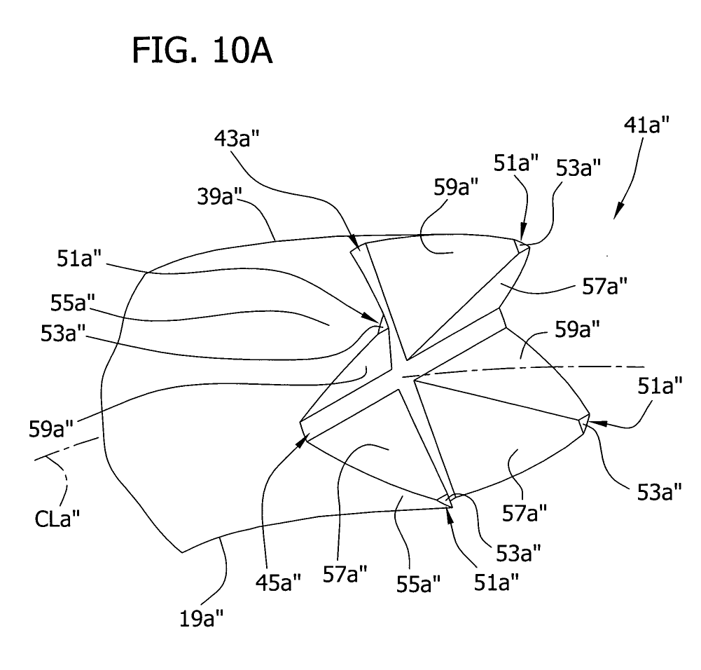

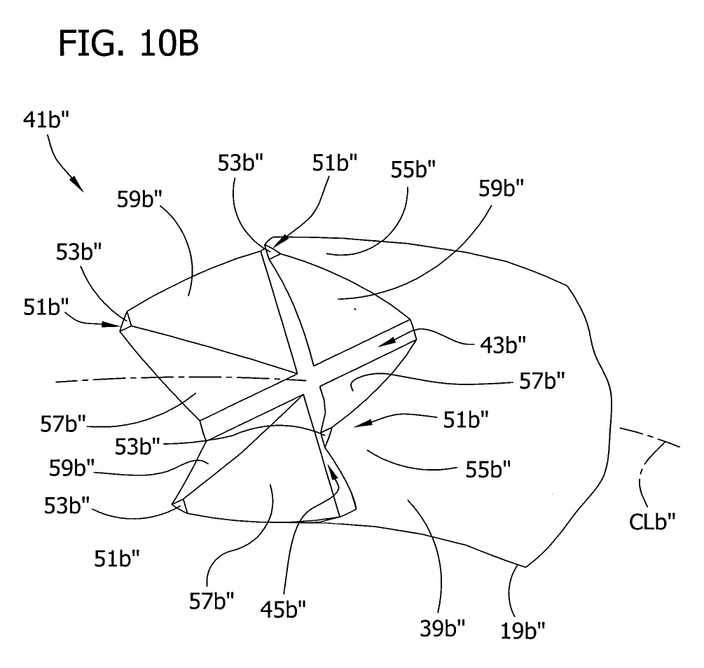

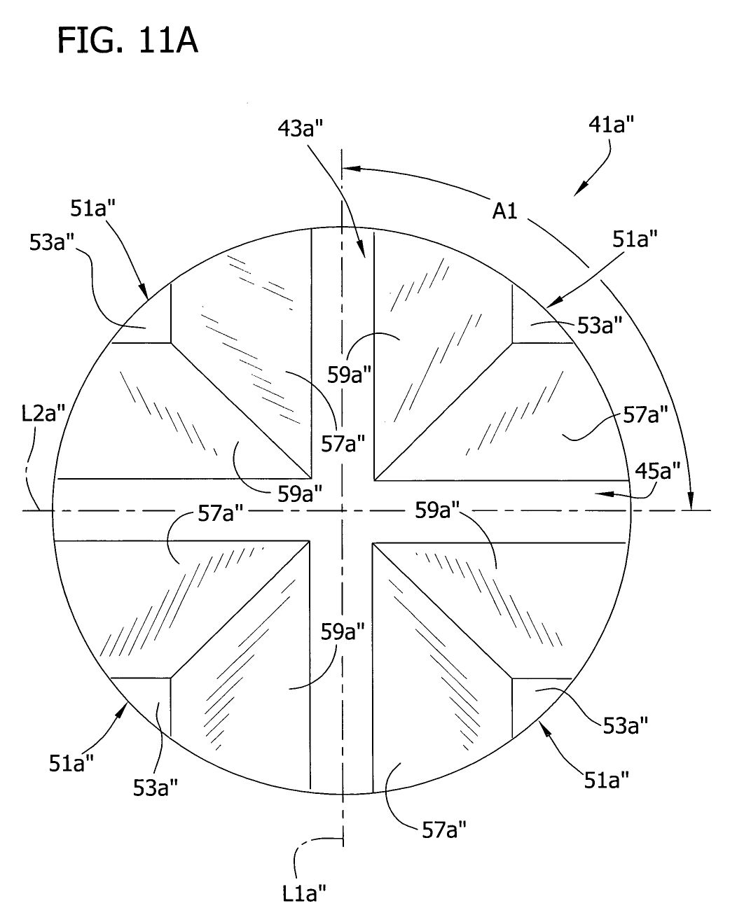

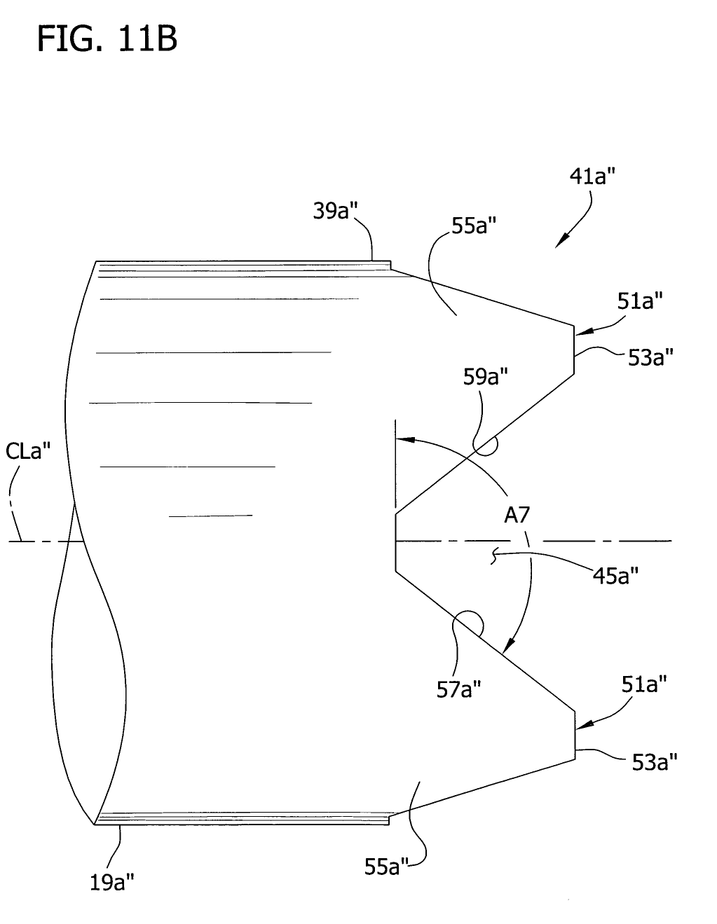

FIGS. 7A-9 illustrate a pair of interlocking formations according to a second version of the first embodiment incorporated into a pair of ring members 19a′, 19b′ and designated generally by reference numerals 41a′ and 41b′, respectively. The shapes of these interconnecting formations 41a′, 41b′ are substantially the same as the shapes of the interconnecting formations 41a, 41b previously described and illustrated in FIGS. 1-6B with the exception that the angle A7 (FIG. 8B) between flat side walls 57a′, 59a′, 57b′, 59b′ of each finger and a floor of a respective recess 43a′, 45a′, 43b′, 45b′ is generally greater than about 90°. In particular, in the illustrated formations 41a′, 4lb′ this angle A7 is about 105°. Accordingly, flat tops 53a′, 53b′ of each finger of this version are somewhat smaller than the flat tops 53a, 53b of the fingers of the previous version. In all other aspects, the interlocking formations 41a′, 41b′ of this version are the same as the formations 41a, 41b of the first version. It is to be understood that a mechanism having joining ring members with interlocking formations in which this angle is more or less than about 105° does not depart from the scope of the invention (e.g., FIGS. 10-12 illustrate ring members 19a″, 19b″ with a pair of corresponding interlocking formations 41a″, 41b″ according to a third version of this embodiment and having an angle A7 (FIG. 11B) between flat side walls 57a″, 59a″, 57b″, 59b″ of each finger and floors of respective recesses 43a″, 45a″, 43b″, 45b″ greater than about 105°).

It should be apparent that a benefit of the interlocking formations of the second and third versions of the first embodiment is that they are generally capable of facilitating mutual adjustment between closing ring members in addition to holding closed ring members in accurate alignment. The fingers of these mating formations are relatively angled. So when the interlocking formations engage, the fingers actively urge misaligned ring members into alignment. More specifically, if paired ring members are misaligned prior to closing, flat side walls of fingers of one ring member engage flat tops of fingers of the other ring member and urge the flat tops toward respective recess floors. Thus, the fingers are capable of moving the paired ring members into proper alignment, both in a direction hat is parallel to a longitudinal axis of the ring binder mechanism and in a direction that is perpendicular to the longitudinal axis of the ring binder mechanism.

A benefit of all of the versions of interlocking formations of this embodiment is that they can be formed by a relatively simple cutting process (e.g., milling or grinding) applied to the free end of each paired ring member. In particular, it is envisioned that a cutting tool (e.g., cutting blade) can be used to form each recess of each interlocking formation. Many of the cuts can be made across the full width of the ring member. The cutting tool is relatively larger and more durable than tools commonly used to form bore holes of prior art ring tip formations, and is therefore less likely to break during the manufacturing process. The cuts also do not impact the structural integrity of the ring members as contrasted to cuts confined to an area within the periphery of the free end of the ring member. Accordingly, it is believed that ring members incorporating the interlocking formations described and illustrated herein can be produced more efficiently and at lower costs than prior art ring members. Moreover, since each of the paired ring member has the same interlocking formation, the same cutting process can be applied to both paired ring members. The only required variation is that one ring member of each pair must be rotated about its centerline relative to the other ring member to produce the desired complimentary arrangement. This can help improve quality control and ensure accurate alignment of the paired ring members of all rings produced.

Another benefit of this invention is that the fingers are relatively sized to ensure that corresponding fingers fit securely together when the ring members are closed and hold the closed ring members in relatively exact alignment in all directions transverse to centerlines of the ring members. Retained pages are therefore capable of repeatedly passing freely along the rings without catching or tearing. The fingers of the mating formations are additionally relatively blunt. This can help prevent injuries to operators when the ring members move together, and may also prevent damage to pages as they are added or removed. Moreover, the fingers are generally integral with each ring member and are therefore relatively sturdy, and this in addition to their shape helps resist damage that may result from repeated engagement of the interlocking formations. Accordingly, mechanisms having ring members incorporating these interlocking formations may last longer and may be more reliable for repeated use than mechanisms having ring members incorporating prior art formations.

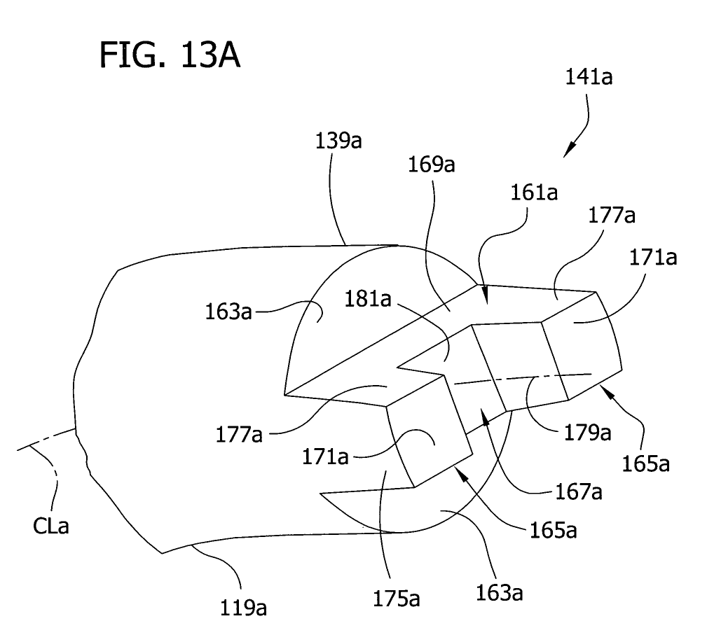

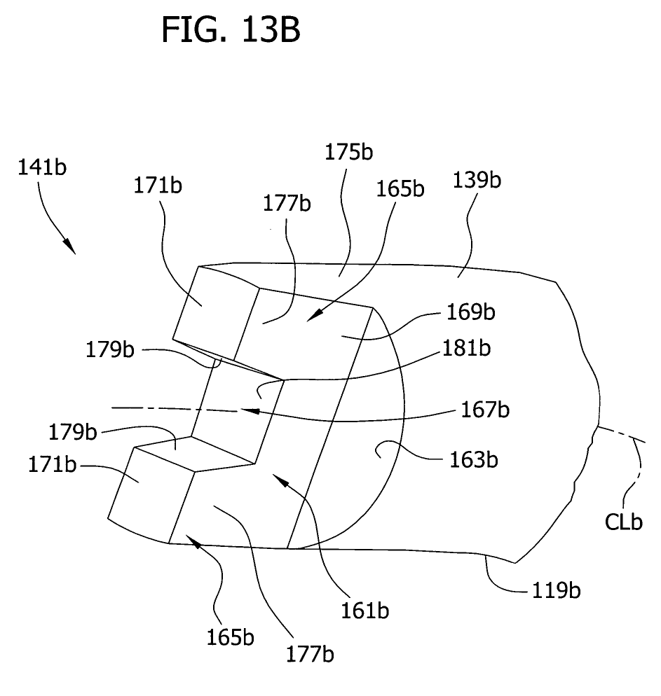

A pair of interlocking formations according to a second embodiment of the invention are illustrated in FIGS. 13A-16 and are designated generally by reference numerals 141a and 141b, respectively. The formations 141a, 141b of this embodiment are similar to the formations 41a, 41b, 41a′, 41b′, 41a″, 41b″ of the first embodiment, and parts of the formations of this embodiment corresponding to parts of the formations of the first embodiment are designated by the same reference numerals, plus “100”. As was true for the formations of the first embodiment and as is shown in FIGS. 13A and 13B, the pair of interlocking formations 141a, 141b of this embodiment each have substantially the same shape. So for convenience, a first interlocking formation 141a will be described hereinafter with it to be understood that a description of a second, mating interlocking formation 141b would be substantially the same.

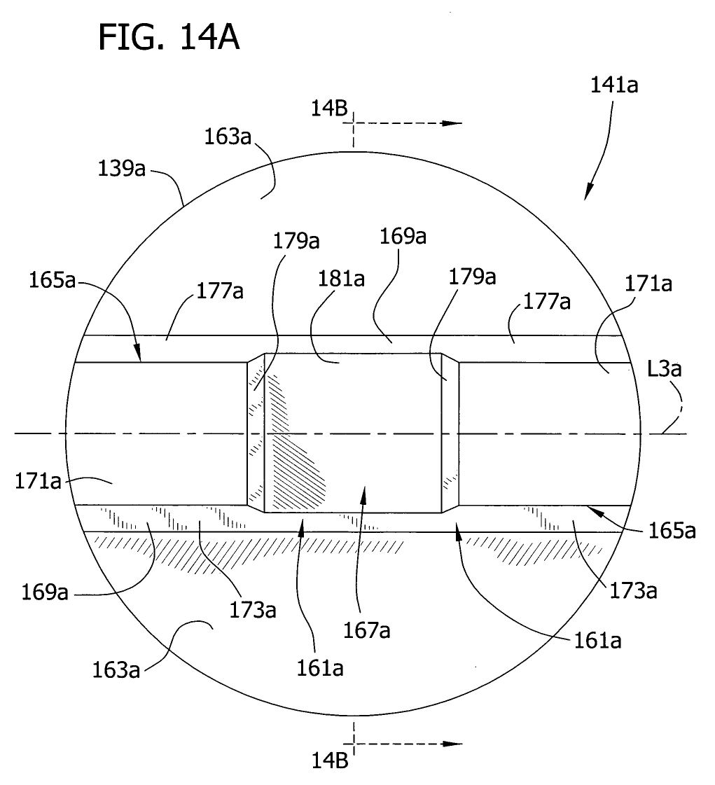

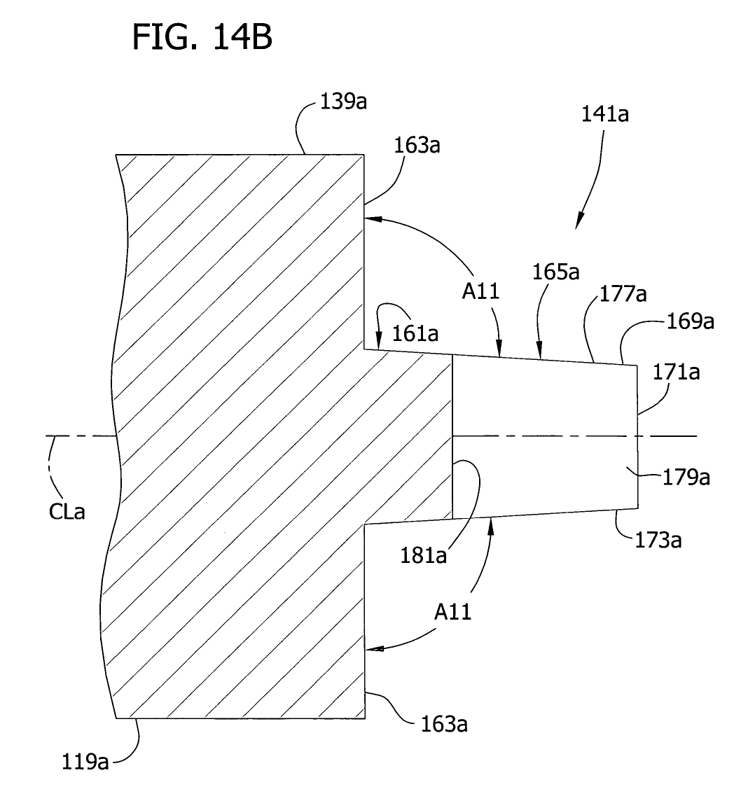

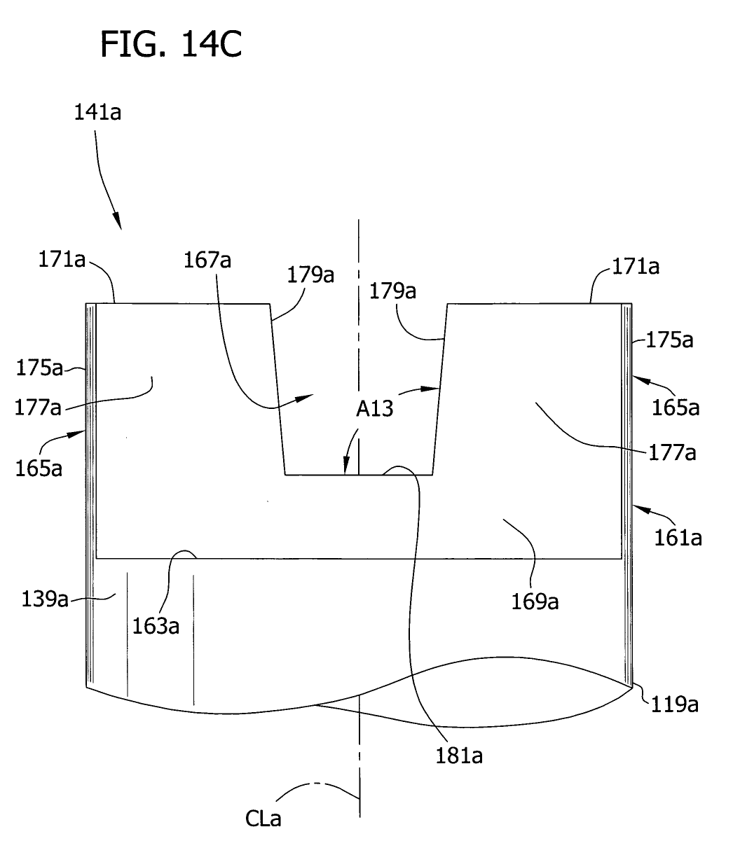

Referring to FIGS. 13A and 14A-14C, the first interlocking formation 141a comprises a generally fork-shaped tongue positioned on a free end 139a of a ring member and designated generally by reference numeral 161a. The tongue 161a extends the full width of the free end 139a along longitudinal axis L3a and is bound on either side by two open recesses that each have floors 163a. The tongue 161a extends longitudinally outward from the free end 139a generally above the recess floors 163a. The tongue 161a includes two substantially identical fingers, each designated generally by reference numeral 165a, positioned adjacent a perimeter of the free end 139a and separated from each other by a central, shallow recess, designated generally by reference numeral 167a. The tongue 161a has two generally “U”-shaped lateral walls 169a that angle relatively inward (i.e., toward each other) as they extend outward from the free end 139a. Each lateral wall 169a forms an angle A11 (FIG. 14B) with the respective recess floor 163a that is greater than about 90°. However, this angle could be larger or smaller than 90° without departing from the scope of the invention. It is envisioned that the tongue 161a is formed integral with the ring member 119a, however a mechanism with ring members having tongues separately attached does not depart from the scope of the invention. It is understood that a mechanism with joining ring members having a cross section that does not necessarily have a diameter, for example an oval cross section, does not depart from the scope of this invention.

The fingers 165a each generally include a relatively flat top 171a and four side walls 173a, 175a, 177a, 179a. A surface of each top 171a is relatively parallel to surfaces of the other tops and to surfaces of each recess floor 163a. Two of the side walls 173a, 177a of each finger form part of the “U”-shaped lateral walls 169a of the tongue 161a. A third side wall 175a is arcuate and aligns with an outer surface of the ring member 119a, and a fourth side wall 179a is opposite the arcuate side wall 175a and angles away from a longitudinal centerline CLa of the ring member 119a as the side 179a extends outward from the free end 139a (FIG. 14C). As shown in FIG. 14C, this fourth side 179a forms an angle A13 with a floor 181a of the shallow recess (the floor 181a is above the recess floors 163a and is relatively parallel thereto). As illustrated, edges of the tops 171a of the fingers, edges of the recess 167a, and edges formed between lateral walls 169a of the tongue 161a and the recess floors 163a are all relatively sharp. However, a mechanism having formations in which these edges are chamfered does not depart from the scope of the invention. It is envisioned that the pair of interlocking formations 141a, 141b of this embodiment are formed by a cutting process, but a mechanism with ring members having interlocking formations formed by a different process does not depart from the scope of the invention.

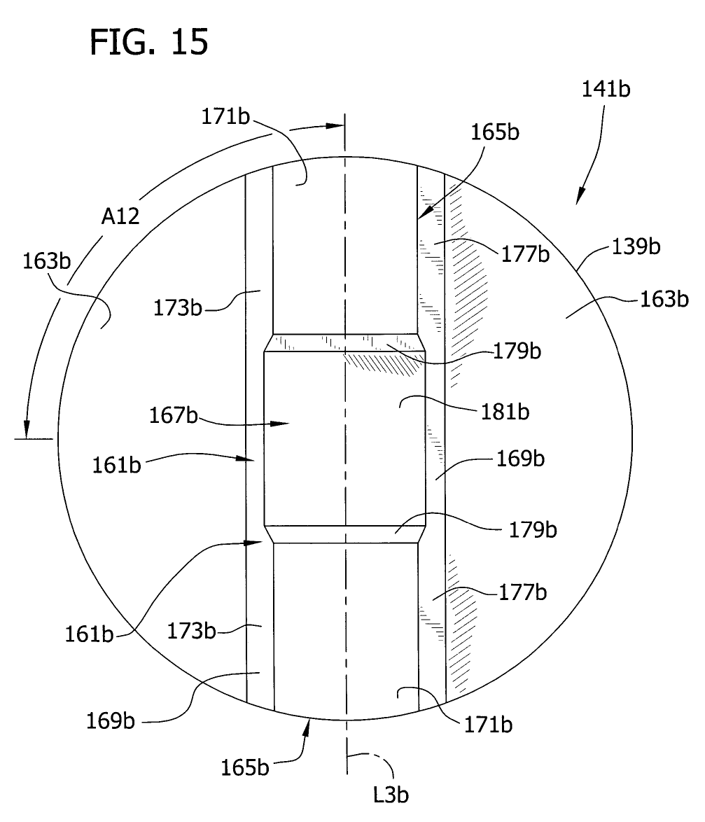

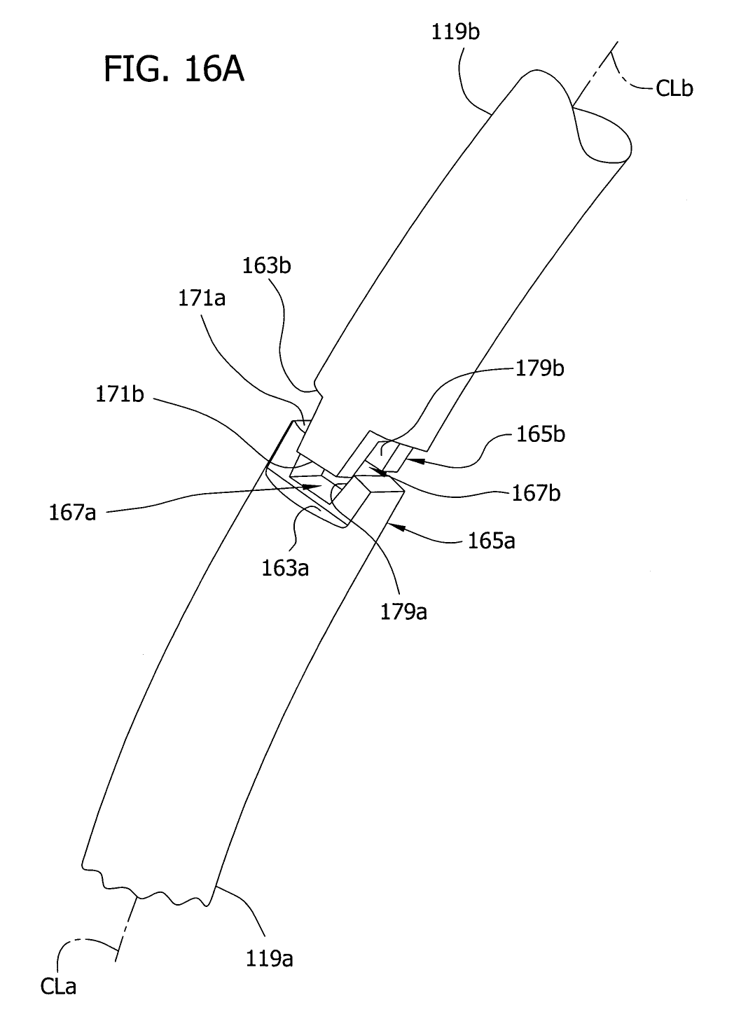

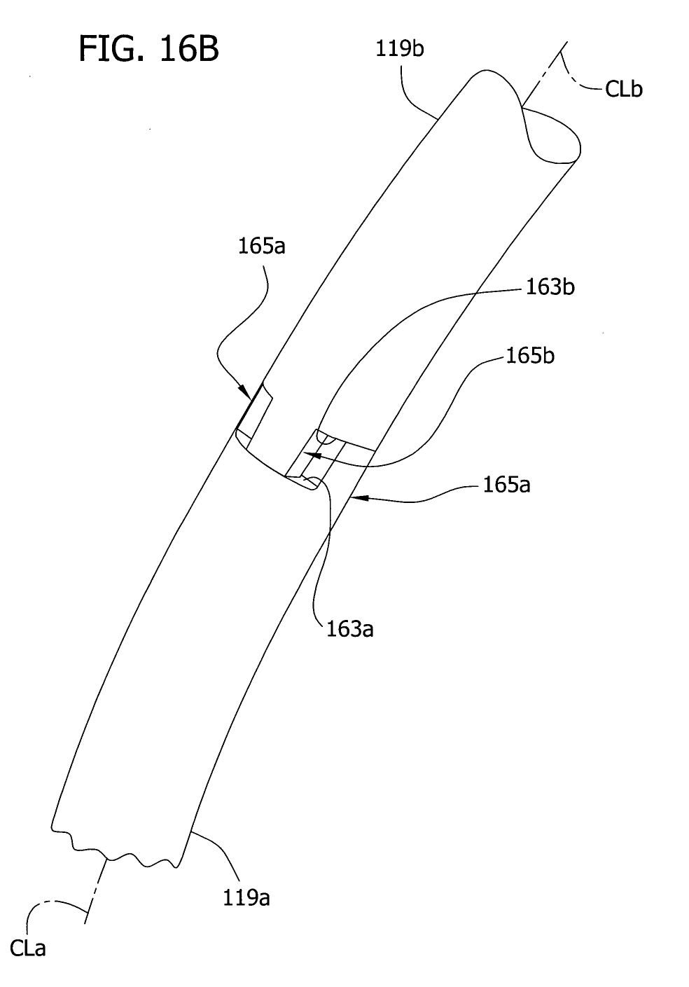

The second, mating interlocking formation 141b is shown in FIGS. 13B and 15. As was previously described, this second formation 141b is shaped substantially the same as the first formation 141a, but as seen by comparing FIG. 14A to FIG. 15, the second interlocking formation 141b (FIG. 15) is rotated an angle A12 relative to the first formation 141a (FIG. 14A). In the illustrated embodiment, the relative angle A12 of rotation is about 90°, but it is understood that a mechanism having free ends with interlocking formations relatively rotated an amount different than about 90° does not depart from the scope of the invention. Referring now to FIGS. 16A and 16B, when the interlocking formations 141a, 141b of this embodiment mate, the recess 167a, 167b of one ring member receives a portion of the tongue 161a, 161b of the other ring member so that when the two ring members 119a, 119b are moved to the closed position they completely align. The tops 171a, 171b of the fingers of one ring member engage the respective recess floors 163a, 163b of the joining ring member, and a portion of the fourth side 179a, 179b of each finger abuts with a corresponding portion of the lateral walls 169a, 169b of each tongue 161a, 161b. Thus, the ring members 119a, 119b generally completely align in all directions transverse to longitudinal centerlines CLa and CLb of the ring members.

It is understood that the pair of interlocking formations of this embodiment have the same general benefits and advantages as the formations of the first embodiment. Accordingly, the benefits and advantages previously described for the formations of the first embodiment equally apply to the formations of this embodiment and will not be restated.

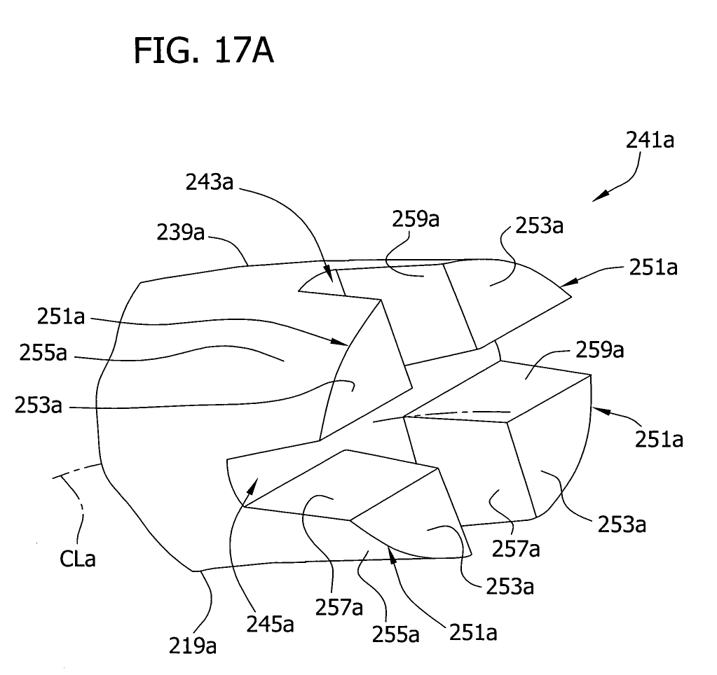

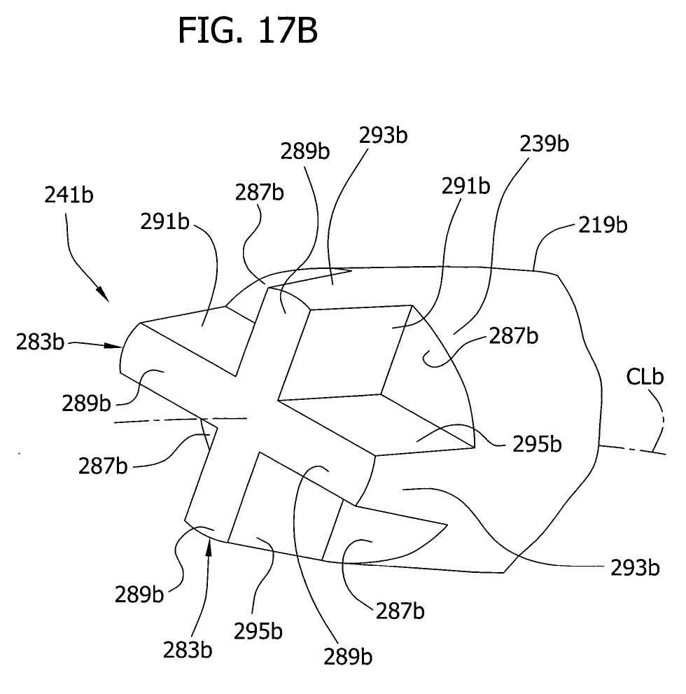

A pair of interlocking formations according to a third embodiment of the invention are illustrated in FIGS. 17A-19 and are designated generally by reference numerals 241a and 241b, respectively. The formations 241a, 241b of this embodiment are similar to the formations 41a, 41b, 41a′, 4lb′, 41a″, 41b″ of the first embodiment previously described and illustrated (FIGS. 1-12), and parts of the formations of this embodiment corresponding to parts of the formations of the first embodiment are designated by the same reference numerals, plus “200”. As seen by comparing FIG. 17A to FIG. 17B, the pair of formations 241a, 241b of this embodiment do not share the same shape. In particular, a first formation 241a of the pair has a general female shape that is substantially similar to the shape of the interlocking formations 41a, 41b, 41a′, 41b′, 41a″, 41b″ of the first embodiment, and more specifically to the shape of the formations 41a′, 41b′ (FIGS. 7A-9) of the second version. Therefore, the previous description of those formations are generally applicable here. A second, mating interlocking formation 241b has a general male shape that will now be described.

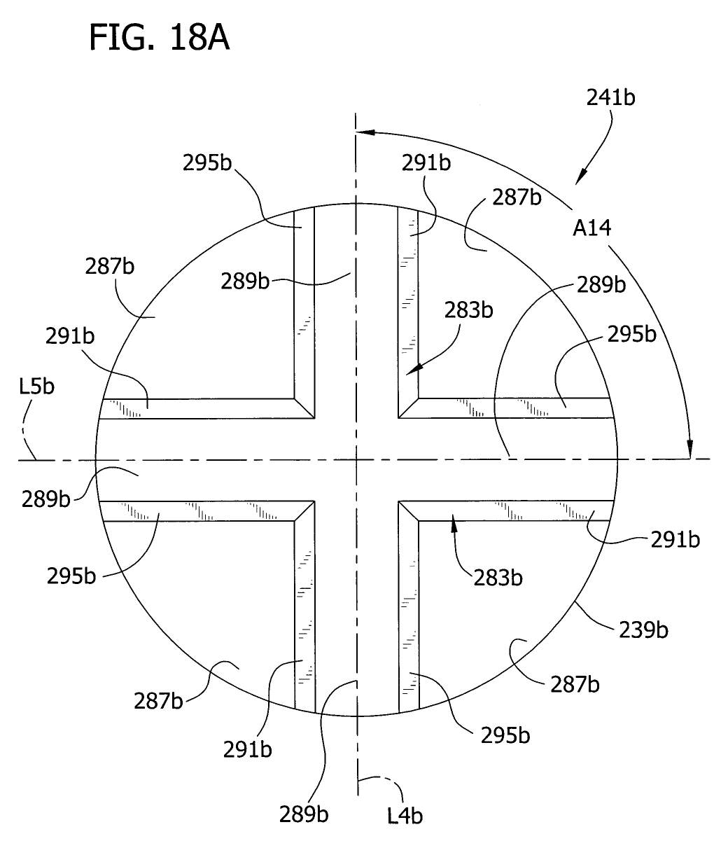

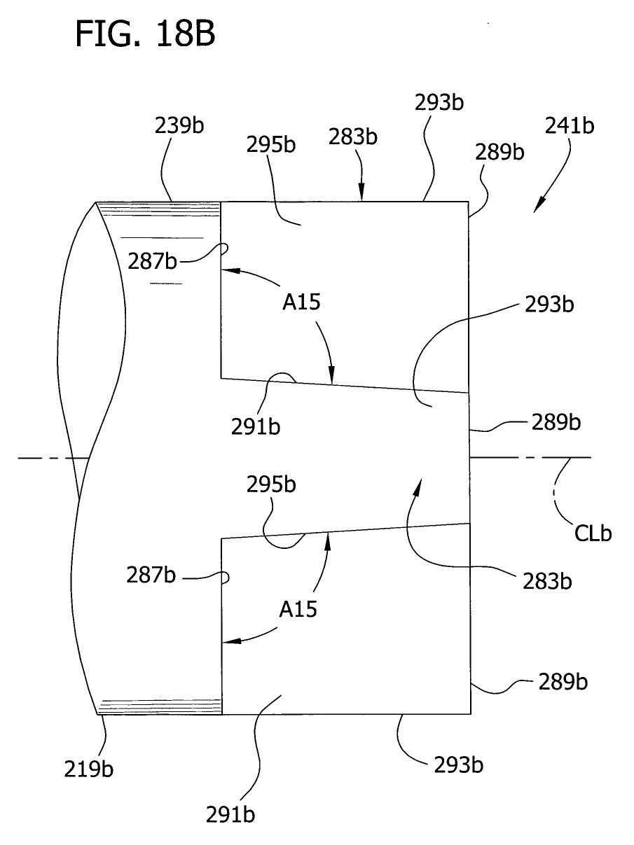

The male interlocking formation 241b is shown in FIGS. 17B, 18A, and 18B and is generally cruciform. It generally comprises two substantially identical tongues, each designated by reference numeral 283b, having longitudinal axes L4b and L5b, respectively. The tongues 283b are symmetrically positioned on a free end 239b of a ring member and uniformly extend along diameters of the free end. The tongues 283b intersect about at a center of the free end 239b, and each further extends longitudinally outward from the free end about the same distance. Together, the crossing tongues 283b quarter the free end 239b into relatively identical open recesses each having a plateau 287b. The tongues 283b are oriented at an angle A14 (FIG. 18A) relative to one another, corresponding to the relative orientation of recesses 243b, 245b of the female interlocking formation (FIG. 17A, see also FIG. 8A). In the illustrated embodiment, the angle A14 between the crossing tongues 283b is about 90°, matching the corresponding angle A1 between the recesses 243b, 245b of the female interlocking formation (see FIG. 8A). It is understood that these angles can be different from 90° without departing from the scope of the invention. It is envisioned that each tongue 283b is integral with the free end 239b of the ring member, but ring members having tongues formed separately therefrom do not depart from the scope of the invention.

Each tongue 283b generally includes a top wall 289b and three side walls 291b, 293b, 295b. As shown best in FIGS. 17B and 18B, surfaces of the top walls 289b of each tongue 283b are generally parallel to surfaces of each plateau 287b. One side wall 293b of each tongue is generally arcuate and is a continuous extension of an outer surface of the ring member 219b. The other walls 291b, 295b are laterally positioned on each tongue 283b and angle relatively inward (i.e., toward each other) as they extend outward from the free end 239b, forming an angle A15 (FIG. 18B) with each respective plateau 287b that is greater than about 90°. As in the previous embodiments, edges of the illustrated interlocking formations 241a, 241b of this embodiment are relatively sharp, but it is understood that a mechanism having joining ring members with interlocking formations in which edges are chamfered does not depart from the scope of the invention. Moreover, a mechanism having ring members with a male interlocking formation having greater or fewer than two tongues does not depart from the scope of the invention as long as a mating female interlocking formation is correspondingly designed.

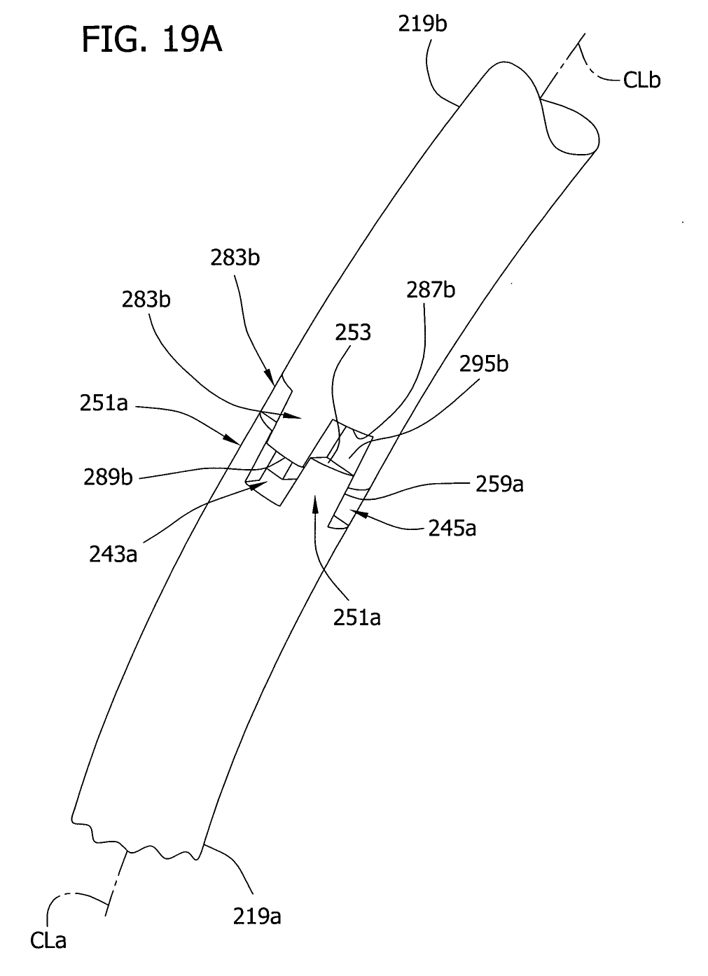

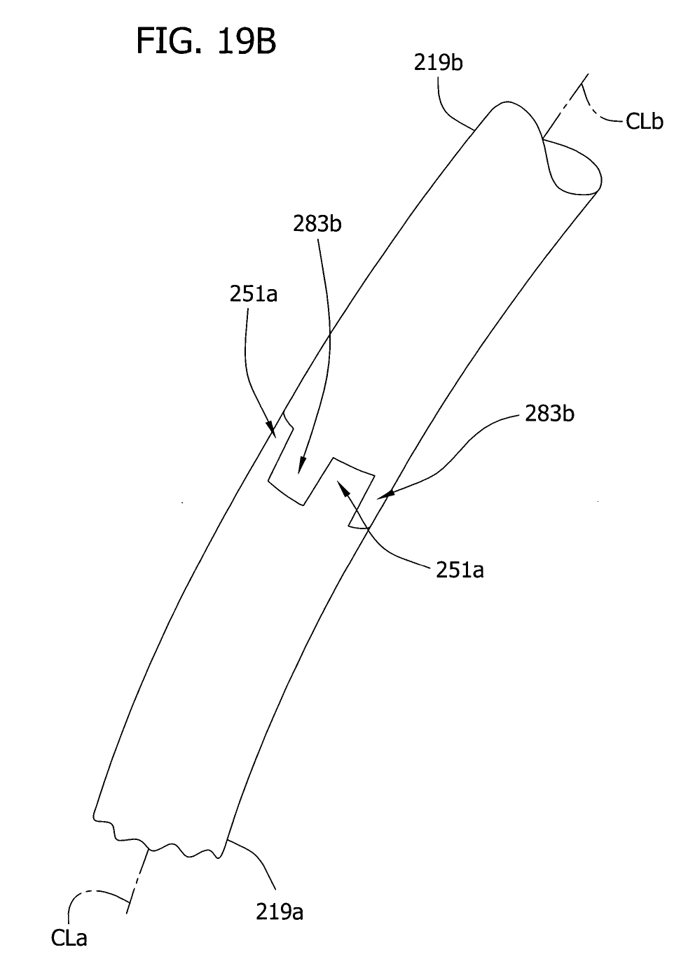

As shown in FIGS. 19A and 19B, when paired ring members 219a, 219b incorporating the interlocking formations 241a, 241b of this embodiment close, the tongues 283b of the male formation accurately fit within the recesses 243a, 245a of the female formation so that when the two ring members are in the closed position they completely align. The tops 289b of the tongues 283b engage floors of the respective recesses 243a, 245a, and the lateral side walls 291b, 295b of each tongue abut corresponding side walls 257a, 259a of fingers of the female formation (the side walls 257a, 259a of the fingers correspond to side walls of the recesses 243a, 245a), thus ensuring generally accurate alignment of the ring members 219a, 219b in all directions transverse to longitudinal centerlines CLa and CLb of the ring members.

This pair of interlocking formations shares several of the previously described benefits and advantages associated with the interlocking formations of the first and second embodiments. For example, lateral side walls of the tongues of the male formation and flat side walls of the fingers of the corresponding female formation are generally angled to help guide the joining ring members together from a comparatively wide misalignment by actively urging the ring members into proper alignment as they close. The general shapes of the interlocking formations ensure that the tongues securely fit together with the corresponding recesses and hold the closed ring members in accurate alignment in all directions transverse to the longitudinal centerlines of the ring members. The male and female formations of this embodiment are also formed as one piece with the ring members and are therefore relatively durable and can resist repeated engagement without damage. It is understood that other advantages and benefits of the first and second embodiments are also generally applicable to this pair of interlocking formations without being restated.

Components of the mechanism of the present invention are made of a suitable rigid material, such as metal (e.g. steel). But mechanisms made of a non-metallic material, specifically including plastic, do not depart from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations thereof is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

1. A ring binder mechanism for retaining loose-leaf pages, the mechanism comprising:
a housing;
rings supported by the housing for holding loose-leaf pages, each ring including a first ring member and a second ring member, each ring member further including a longitudinal centerline;
the first ring member being moveable relative to the second ring member so that in a closed position a free end of the first ring member joins with a free end of the second ring member and in an open position the free end of the first ring member separates from the free end of the second ring member; and
the free end of the first ring member having an interlocking formation having a shape and the free end of the second ring member having an interlocking formation having a shape substantially identical to the shape of the first ring member, the interlocking formation of the second ring member being rotated about the longitudinal centerline of the second ring member relative to the interlocking formation of the first ring member an angle that is greater than 0° but less than 90°.

2. A ring binder mechanism as set forth in claim 1 wherein the interlocking formations of the first and second ring members each include at least three spaced apart fingers.

3. A ring binder mechanism as set forth in claim 2 wherein the fingers are located at the periphery of the corresponding ring member.

4. A ring binder mechanism as set forth in claim 2 wherein the relative angle of rotation between the interlocking formations generally equals 180° divided by the number of fingers.

5. A ring binder mechanism as set forth in claim 4 wherein the interlocking formations include four substantially identical fingers symmetrically positioned around a perimeter of the free end of each ring member.

6. A ring binder mechanism as set forth in claim 5 wherein the angle of rotation of the interlocking formation of the second ring member about the longitudinal centerline of the second ring member relative to the interlocking formation of the first ring member is about 45°.

7. A ring binder mechanism as set forth in claim 1 wherein the interlocking formation of the first ring member includes at least two recesses that each extend along a surface of the free end of the first ring member a full dimension of the first ring member transverse to the longitudinal centerline of the first ring member, the two recesses intersecting about where the longitudinal centerline of the first ring member extends through said free end.

8. A ring binder mechanism as set forth in claim 7 wherein the recesses are relatively oriented so that an angle between longitudinal axes of the respective recesses is about 90°.

9. A ring binder mechanism as set forth in claim 1 wherein the interlocking formation of the first ring member positively engages the interlocking formation of the second ring member for actively urging the ring members into alignment as they close and for resisting misalignment of the closed ring members both in a direction that is parallel to a longitudinal axis of the ring binder mechanism and in a direction that is perpendicular to the longitudinal axis of the ring binder mechanism.

10. A ring binder mechanism as set forth in claim 1 in combination with a cover on which the ring binder mechanism is mounted.

11. A ring binder mechanism for retaining loose-leaf pages, the mechanism comprising:
a housing;
rings supported by the housing for holding loose-leaf pages, each ring including a first ring member and a second ring member and having a longitudinal centerline;
the first ring member being moveable relative to the second ring member between a closed position in which a free end of the first ring member joins with a free end of the second ring member and an open position in which the free ends of the ring members are separated;
the first and second ring members each having an interlocking formation at the free end interengagable with the interlocking formation of the other ring member in the closed position to resist misalignment of the closed ring members both in a direction that is parallel to a longitudinal axis of the ring binder mechanism and in a direction that is perpendicular to the longitudinal axis of the ring binder mechanism; and
the interlocking formation of the first ring member comprising at least three substantially identical and spaced apart fingers extending longitudinally outward therefrom.

12. A ring binder mechanism as set forth in claim 11 wherein the fingers of each interlocking formation are located at a periphery of the free end of their respective ring member, and wherein the first ring member has an outer surface, the fingers each having a side that is a continuous extension of the outer surface of the first ring member.

13. A ring binder mechanism as set forth in claim 12 wherein a shape of the interlocking formation of the second ring member is substantially identical to a shape of the interlocking formation of the first ring member.

14. A ring binder mechanism as set forth in claim 11 wherein the interlocking formation of the first ring member comprises four fingers.

15. A ring binder mechanism as set forth in claim 14 wherein the interlocking formation of the second ring member comprises two tongues for interengaging with the fingers of the first ring member when the ring members are in the closed position.

16. A ring binder mechanism for retaining loose-leaf pages, the mechanism comprising:
a housing;
rings supported by the housing for holding loose-leaf pages, each ring including a first ring member and a second ring member, each ring member further including a longitudinal centerline;
the first ring member being moveable relative to the second ring member between a closed position in which a free end of the first ring member joins with a free end of the second ring member and an open position in which the free ends of the ring members are separated;
the first and second ring members each having an interlocking formation at the free end interengagable with the interlocking formation of the other ring member in the closed position to resist misalignment of the ring members;
the interlocking formations of the first and second ring members each having at least two recesses; and
the recesses of the interlocking formation of the first ring member extending along a surface of the free end the full dimension of the first ring member transverse to the longitudinal centerline of the first ring member, said recesses intersecting about where the longitudinal centerline of the first ring member extends through said surface of the free end.

17. A ring binder mechanism as set forth in claim 16 wherein the recesses of the interlocking formation of the first ring member have a uniform depth along their length and each have a longitudinal axis that is generally perpendicular to the longitudinal centerline of the first ring member.

18. A ring binder mechanism as set forth in claim 17 wherein interlocking formation of the first ring member includes two recesses relatively oriented so that an angle between the longitudinal axes of the respective recesses is about 90°.

19. A ring binder mechanism as set forth in claim 18 wherein the interlocking formation of the second ring member has a shape substantially identical to a shape of the interlocking formation of the first ring member.

20. A ring binder mechanism as set forth in claim 18 wherein the interlocking formation of the second ring member comprises two tongues adapted to fit in the recesses of the first ring member when the ring members are in the closed position.

21. A ring binder mechanism for retaining loose-leaf pages, the mechanism comprising:
a housing;
rings supported by the housing for holding loose-leaf pages, each ring including a first ring member and a second ring member, each ring member further having a width and a longitudinal centerline;
the first ring member being moveable relative to the second ring member so that in a closed position a free end of the first ring member joins with a free end of the second ring member and in an open position the free end of the first ring member separates from the free end of the second ring member;
the free end of the first ring member having a tongue extending along a surface of the free end transversely to the longitudinal centerline of the first ring member;
the free end of the second ring member having a recess extending uniformly along a surface of the free end transversely to the longitudinal centerline of the second ring member the full width of the second ring member, the recess of the second ring member being adapted to receive the tongue of the first ring member; and
the recess of the second ring member and the tongue of the first ring member being arranged relative to each other such that when the free ends of the two ring members join in the closed position the recess and tongue interact to resist misalignment of the closed ring members both in a direction that is parallel to a longitudinal axis of the ring binder mechanism and in a direction that is perpendicular to the longitudinal axis of the ring binder mechanism.

22. A ring binder mechanism as set forth in claim 21 wherein the recess and tongue each extend in a direction transverse to the respective one of the first and second ring members, in the closed position of the ring members said direction being skew to the longitudinal axis of the ring binder mechanism and to said direction perpendicular to the longitudinal axis.

23. A ring binder mechanism as set forth in claim 22 wherein the free end of the second ring member is formed with opposing flat walls defining at least a portion of the recess between them, and wherein the tongue of the first ring member includes flat walls arranged for face-to-face positioning with a respective one of the flat walls defining the recess for interengagment to resist relative movement of the first and second ring members in the directions parallel and perpendicular to the longitudinal axis of the ring binder mechanism.

24. A ring binder mechanism as set forth in claim 23 wherein the flat walls defining the recess and the flat walls of the tongue lie in planes which are skew to said direction parallel to the longitudinal axis and skew to said direction perpendicular to the longitudinal axis.

25. A ring binder mechanism as set forth in claim 21 wherein the tongue comprises two spaced apart fingers extending longitudinally outward therefrom and terminating in blunt ends.

26. A ring binder mechanism as set forth in claim 21 wherein the free end of the first ring member has two substantially identical tongues intersecting each other, and wherein the free end of the second ring member has two substantially identical recesses for receiving said tongues.

27. A ring binder mechanism for retaining loose-leaf pages, the mechanism comprising:
a housing;
rings supported by the housing for holding loose-leaf pages, each ring including a first ring member and a second ring member, each ring member further including a longitudinal centerline and an outer surface;
the first ring member being moveable relative to the second ring member so that in a closed position a free end of the first ring member joins with a free end of the second ring member and in an open position the free end of the first ring member separates from the free end of the second ring member;
the free end of the first ring member having an interlocking formation with a shape and the free end of the second ring member having an interlocking formation having a shape substantially identical to the shape of the interlocking formation of the first ring member, the interlocking formations each comprising a tongue extending longitudinally outward from a surface of the free end and extending along a surface transversely to the longitudinal centerline of the respective ring member;
the tongues of both ring members having two spaced apart fingers extending longitudinally outward from the tongue and terminating in blunt ends for preventing the fingers from inadvertently tearing the pages retained by the mechanism; and
the interlocking formation of the second ring member being rotated about the longitudinal centerline of the second ring member relative to the interlocking formation of the first ring member an angle that is about 90°.

28. A ring binder mechanism as set forth in claim 27 wherein the ring members each have an outer surface, the fingers each ring member having a side that is a continuous extension of said outer surface.

29. A ring binder mechanism as set forth in claim 28 wherein the fingers are separated by a recess, the recess of each ring member receiving a portion of the tongue of the opposite ring member.
